(19) United States
(12) Patent Application Publication
(10) Pub. No.: US 2014/0107839 A1
(43) Pub. Date: Apr. 17, 2014

(54) HIGH EFFICIENCY, SMOOTH ROBOT DESIGN

(71) Applicant: Massachusetts Institute of Technology, Cambridge, MA (US)

(72) Inventors: Haruhiko Harry Asada, Lincoln, MA (US); Anirban Mazumdar, Albuquerque, NM (US); Martin Lozano, Austin, TX (US); Aaron Michael Fittery, Fort Collins, CO (US)

(73) Assignee: Massachusetts Institute of Technology, Cambridge, MA (US)

(21) Appl. No.: 14/052,598

(22) Filed: Oct. 11, 2013

Related U.S. Application Data
(60) Provisional application No. 61/714,290, filed on Oct. 16, 2012.

(51) Int. Cl. B25J 9/16

(52) U.S. Cl. CPC B25J 9/1651
USPC 700/253

(57) ABSTRACT

An underwater robot includes a body, a propeller connected to an end of the body, a controller, and first and second actuation units that output jets of fluid. The propeller propels the robot, and the controller stabilizes the robot using the jets of fluid. The controller determines which actuation unit to activate based on a calculation involving a yaw rate and a yaw angle of the robot.

### CROSS-REFERENCE TO RELATED APPLICATIONS

This patent application claims priority to U.S. provisional patent application 61/714,290, filed Oct. 16, 2012, which is incorporated by reference along with all other references cited in this application.

### TECHNICAL FIELD

The present invention relates to the field of underwater vehicles, including, more particularly, to underwater robots.

### BACKGROUND OF THE INVENTION

There is a continuing demand for underwater robots that can access confined spaces and efficiently move through the water. For example, to access complex underwater structures, it is desirable that robots be tetherless, compact, highly maneuverable, and have a smooth body shape with minimal appendages. These requirements are challenging because few propulsive systems can be designed to fit into a smooth, streamlined body. A moment referred to as the “Munk moment” is destabilizing for elongated bodies. For example, the moment tends to rotate them broadside to the flow.

Thus, there is a need to provide improved robotic systems and techniques.

### BRIEF SUMMARY OF THE INVENTION

In a specific implementation, an underwater robot includes a body, a propeller connected to an end of the body, a controller, and first and second actuation units that output jets of fluid. The propeller propels the robot, and the controller stabilizes the robot using the jets of fluid. The controller determines which actuation unit to activate based on a calculation involving a yaw rate and a yaw angle of the robot.

An emerging area in marine robotics is the development of robots that are capable of maneuvering within tight constraints and otherwise cluttered and constrained environments. Examples of such applications include the inspection of nuclear reactors, water-filled piping structures, evaluation of underwater infrastructure and even the exploration of confined spaces deep underwater. Other examples of applications include underwater studies and exploration of sea animals, plants, ice, military and security applications such as surveillance, explosive ordnance disposal (EOD), meteorology, port security, mine countermeasures (MCM), and maritime ISR (Intelligence, Surveillance, Reconnaissance).

Developing underwater robots that can maneuver at low speeds and in tight spaces is still an emerging area of research. This patent application describes a new class of underwater robots that combine high performance centrifugal pumps with fluidic valves to achieve multi-degree-of-freedom (DOF) maneuvering capability.

In a specific implementation, an underwater robot includes a body having a first end and a second end, a propeller coupled to the first end of the body, a controller having a processor for receiving sensor information and for causing control signals to be generated, and first and second actuation units responsive to the controller processor control signals, where the first and second actuation units are positioned inside the body, and each actuation unit includes a pump and two valves coupled to the pump. As the propeller propels the robot, the controller causes jets of fluid outputted from the first and second actuation units to stabilize the movement of the robot.

In another specific implementation, a method for stabilizing an underwater robot moving in a first direction includes measuring a yaw angle of the underwater robot, measuring a yaw rate of the underwater robot, using a processor associated with a controller, making a calculation involving the measured yaw angle and the measured yaw rate, and based on the calculation, the controller generating signals for actuating at least one of a first jet, or a second jet to stabilize the underwater robot moving in the first direction, where the first jet points in a second direction that is different from the first direction, and the second jet points in a third direction that is different from the first direction.

In another specific implementation, an underwater robot includes a body, a propeller coupled to an end of the body to move the underwater robot in a first direction, a controller having a processor for receiving sensor information and for causing control signals to be generated, a first pump responsive to the controller processor control signals, the first pump including a first valve for outputting a first jet of fluid in a second direction, and a second pump responsive to the controller processor control signals, the second pump including a second valve for outputting a second jet of fluid in a third direction, where the second and third directions are perpendicular to the first direction, and the second and third directions are opposite to each other.

Other objects, features, and advantages of the present invention will become apparent upon consideration of the following detailed description and the accompanying drawings, in which like reference designations represent like features throughout the figures.

### BRIEF DESCRIPTION OF THE FIGURES

The patent or application file contains at least one drawing executed in color. Copies of this patent or patent application with color drawing(s) will be provided by the Office upon request and payment of the necessary fee.

FIG. 1A shows a simplified block diagram of a first embodiment of an underwater robot that includes a propeller and a jet-based stabilizing module.

FIG. 1B shows a more detailed block diagram of the jet-based stabilizing module.

FIG. 1C shows a top view of a prototyped high maneuverability robot having a propeller and 5 degree-of-freedom (DOF).

FIG. 1D shows a bottom view of the robot shown in FIG. 1C.

FIG. 2A shows the propulsion components for the first embodiment of the prototype robot.

FIG. 2B shows a diagram of a fin stabilizing prior art underwater robot in a forward direction.

FIG. 2C shows a diagram of the fin destabilizing the prior art robot in a reverse direction.

FIG. 3A shows a top view of an inside of the first embodiment of the robot including the pump-valve maneuvering system.

FIG. 3B shows an inside of view of a nose cap of the robot and a fluid flow for positive jet 2.

FIG. 3C shows the inside view of the nose cap and a fluid flow for negative jet 2.

FIG. 3D shows an inside view of the tail cap and a fluid flow for positive jet 1.

FIG. 3E shows the inside view of the tail cap and a fluid flow for negative jet 1.

FIG. 3F shows an overall flow of an algorithm for controlling the robot.

FIG. 4A shows a model simulation illustrating the directional instability.

FIG. 4B shows another model simulation illustrating the directional instability.

FIG. 5 shows SISO pole locations for the linearized model.

FIG. 6 shows a simulated time response for the linear stabilizing controller.

FIG. 7 shows simulation results from the fast turn test. Results are open loop.

FIG. 8 shows simulation results from the stationary turn test. Results are open loop.

FIG. 9 shows experimental results for the straight motion test. Note the contrast between the open loop case and the closed loop stabilization.

FIG. 10 shows experimental results for the disturbance test.

FIG. 11A shows experimental results for the high-speed turning tests.

FIG. 11B shows experimental results for the turning-in-place turning tests.

FIG. 11C shows a block diagram of a side view of a robot.

FIG. 11D shows a block diagram of the side view of the robot during a diving motion.

FIG. 11E shows a block diagram of the side view of the robot during a surfacing motion.

FIG. 11F shows a perspective view of a second specific embodiment of a robot.

FIG. 11G shows a top view of a third specific embodiment of a robot.

FIG. 12A shows a top view of a fourth embodiment of a robot having a smooth shape that is appendage free and capable of 5 DOF.

FIG. 12B shows an end view of the robot shown in FIG. 12A.

FIG. 12C shows a top view of the robot shown in FIG. 12A.

FIG. 12D shows a bottom view of the robot show in FIG. 12A.

FIG. 12E shows a front view of the robot shown in FIG. 12A.

FIG. 12F shows a back view of the robot shown in FIG. 12A.

FIG. 13 shows the vehicle body or robot fixed coordinate frame.

FIG. 14 shows a CFD illustration of a 180 degree centrifugal pump.

FIG. 15A shows a schematic of a centrifugal pump having a 90 degree configuration.

FIG. 15B shows the pump in FIG. 15A where the impeller direction is reversed.

FIG. 15C shows a CFD illustration of the pump in FIG. 15A.

FIG. 15D shows a CFD illustration of the pump in FIG. 15B.

FIG. 16A shows a schematic of a valve.

FIG. 16B shows a CFD illustration of the valve in FIG. 16A.

FIG. 17 shows an example of a prototyped valve.

FIG. 18 shows an example of a prototyped actuation unit.

FIG. 19 shows the maneuvering architecture for the robot.

FIG. 20 shows the inside of the robot.

FIG. 21A shows a forward and reverse test of the robot.

FIG. 21B shows a sway direction translation of the robot.

### DETAILED DESCRIPTION

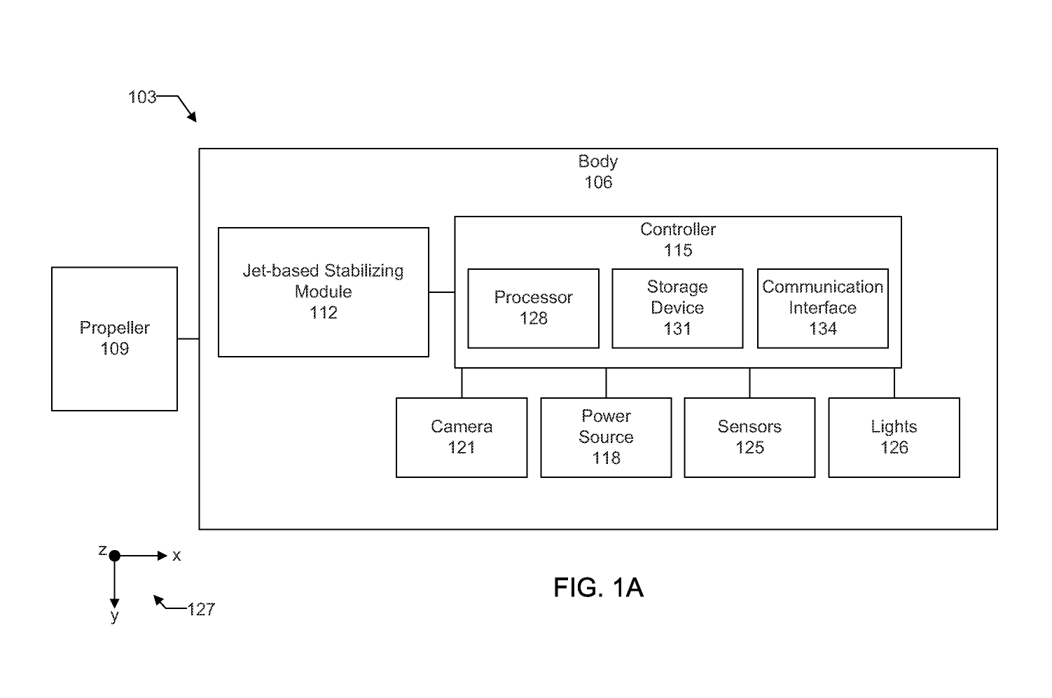

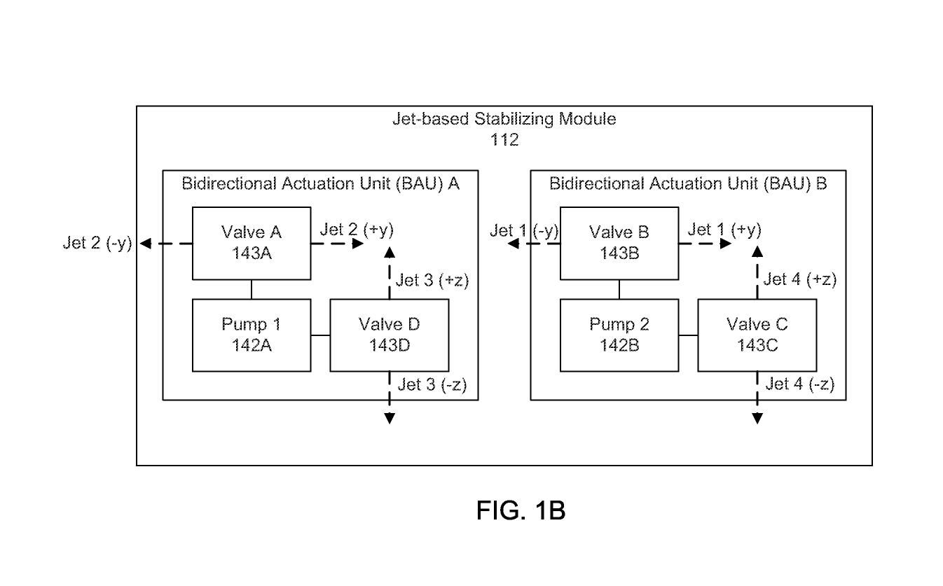

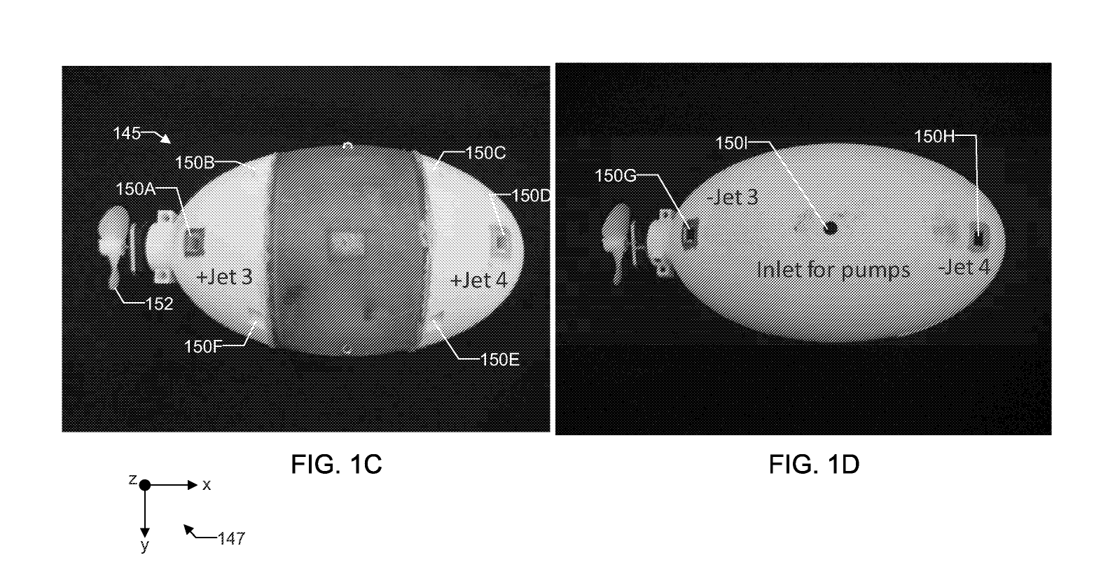

FIG. 1A shows a block diagram of a first embodiment of an underwater vehicle 103. This vehicle includes a body 106 and propeller 109 connected to an end of the body. Positioned inside the body are a jet-based stabilizing module 112 and a controller 115. The controller may be connected to the stabilizing module, a power source 118, a camera 121, a sensor 125, and lighting 126. A set of Cartesian coordinate system axes 127 are shown with the figure to help indicate orientation. There is an x-axis, y-axis, and z-axis. The x and y axes are perpendicular to each other and lie in a first plane. The z-axis lies in a second plane, perpendicular to the first plane.

The controller may include a processor 128, storage device 131, and a communications interface 134. The processor may be referred to as a central processing unit (CPU). The processor may include multiple processors or a multicore processor, which may permit parallel processing of information. The storage device may include mass disk drives, floppy disks, magnetic disks, optical disks, magneto-optical disks, fixed disks, hard disks, CD-ROMs, recordable CDs, DVDs, recordable DVDs (e.g., DVD-R, DVD+R, DVD-RW, DVD+RW, HD-DVD, or Blu-ray Disc®), flash and other nonvolatile solid-state storage (e.g., USB flash drive), battery-backed-up volatile memory, tape storage, reader, and other similar media, and combinations of these.

A computer-implemented or computer-executable version of the invention may be embodied using, stored on, or associated with computer-readable medium or non-transitory computer-readable medium. A computer-readable medium may include any medium that participates in providing instructions to one or more processors for execution. Such a medium may take many forms including, but not limited to, nonvolatile, volatile, and transmission media. Nonvolatile media includes, for example, flash memory, or optical or magnetic disks. Volatile media includes static or dynamic memory, such as cache memory or RAM. Transmission media includes coaxial cables, copper wire, fiber optic lines, and wires arranged in a bus. Transmission media can also take the form of electromagnetic, radio frequency, acoustic, or light waves, such as those generated during radio wave and infrared data communications.

For example, a binary, machine-executable version, of the software of the present invention may be stored or reside in RAM or cache memory, or on storage device 131. The source code of the software may also be stored or reside on storage device 131 (e.g., hard disk, magnetic disk, or flash memory). As a further example, code may be transmitted via wires, radio waves, or through a network such as the Internet.

Communications interface provides a mechanism for allowing the underwater vehicle to receive information, transmit information, or both (e.g., two-way data exchange). The interface may include a wireless communications interface including an antenna. The underwater vehicle may be configured for wireless communication for a wide area network (WAN), local area network (LAN), or various other types of wireless communication bands or frequencies including communications across various frequency bands or spectrums.

Communication protocols may include TCP/IP, HTTP protocols, wireless application protocol (WAP), vendor-specific protocols, Bluetooth (e.g., over IEEE 802.15.1), ultra-wideband (UWB, e.g., over IEEE 802.15.3), ZigBee (e.g., over IEEE 802.15.4), Wi-Fi (e.g., over IEEE 802.11), IPv6 over Low power Wireless Personal Area Networks (6LoWPAN), Wireless HART, ISA 100, WiMi, ANT, ANT+, customized protocols, and others. Communication may be via hardwire links, optical links, satellite or other wireless communications links, wave propagation links, or any other mechanisms for communication of information. In another specific implementation, an underwater vehicle may include a tether (e.g., umbilical cable) to carry electrical power, video and data signals back and forth between the operator and the vehicle. In another specific implementation, the underwater vehicle may be an autonomous robot. For example, an autonomous robot may include logic or artificial intelligence that allows the robot to act and perform desired tasks in an unstructured environment with little or no human guidance.

The sensor can measure a physical quantity and convert it into a signal which can be read by an observer or electronic instrument. There can be multiple sensors. Some specific examples of sensors include a thermocouple, motion sensors (e.g., accelerometers), rotation sensors (gyroscopes), altimeter, microphone, and many others. A sensor may be part of an inertial navigation system (INS) of a specific implementation of an underwater vehicle. An INS is a navigation aid that uses a computer, motion sensors (accelerometers) and rotation sensors (gyroscopes) to continuously calculate via dead reckoning the position, orientation, and velocity (direction and speed of movement) of a moving object without the need for external references.

The power source provides a source of power for propulsion and operation of the various components of the underwater vehicle. The power source can include a battery such as a non-rechargeable battery, a rechargeable battery, or both. Some specific examples of batteries include alkaline battery, lead-acid, lithium-ion, fuel cell, nickel-cadmium, nickel metal hydride, and many others. The power source may instead or additionally include a gasoline engine, diesel engine, diesel-electric engine, a nuclear reactor, or combinations of these.

The camera allows for the capture and recording of images. Images may be stored in the storage device, transmitted to another location, or both. The images may be still photographs or moving images such as videos or movies. There can be multiple cameras. In a specific implementation, there are two cameras. In this specific implementation, a first camera supports real-time navigation and visual examination by the robot operator. A second camera captures higher-resolution imaging data for subsequent inspection, nondestructive evaluation, and asset management applications.

The lighting can include light emitting diodes (LEDs), organic LEDs (OLED), polymer LEDs (PLED), fluorescent lamps, compact fluorescent lamps, halogen lamps, incandescent lamps, or combinations of these. In various specific embodiments, an underwater vehicle may be equipped with sonar, magnetometers, manipulators, cutting arms, sampling tools, lasers, instruments that measure water clarity, quality, light penetration, or temperature, or combinations of these.

Jet-based stabilizing module 112 may be referred to as a pump-valve system. In a specific implementation, the underwater vehicle is a robot. A new type of spherical underwater robot is provided that is completely or substantially smooth and uses jets to propel, maneuver, or both. A specific application is a robot specifically designed for the direct visual inspection of water-filled infrastructure such as the inside of nuclear powerplants.

FIG. 1B shows more detailed block diagram of the jet-based stabilizing module shown in FIG. 1A. In a specific implementation, the module includes a first bidirectional actuation unit (BAU) A 140A and a second bidirectional actuation unit B 140B. Each actuation unit includes a pump and two fluidic valves connected to the pump. For example, the first actuation unit includes a first pump 142A, and first and fourth valves 143A and 143D connected to the first pump. The second actuation unit includes a second pump 142B and second and third valves 143B and 143C connected to the second pump. A bidirectional actuation unit may be referred to as a building block.

As shown in FIG. 1B, first valve 143A outputs, ejects, exhausts, or expels a second jet of fluid. The first valve can output the second jet in a negative y-direction or a positive y-direction. Second valve 143B outputs a first jet of fluid. The second valve can output the first jet in the negative y-direction or the positive y-direction. Third valve 143C outputs a fourth jet of fluid. The third valve can output the fourth jet in a negative z-direction or a positive z-direction. Fourth valve 143D outputs a third jet of fluid. The fourth valve can output the third jet in the negative z-direction or positive z-direction.

In a specific implementation, the first and second valves of the bidirectional actuation units are responsible for stabilizing the robot. The first and second valves can also provide turning and maneuvering capabilities. The third and fourth valves of the bidirectional units are responsible for diving and surfacing.

In this specific implementation, the unique propulsion architecture includes a single bidirectional centrifugal pump combined with two fluidic valves. The pump is used to produce a high velocity jet while the valves are used to quickly switch the jet between output ports. The spherical shape means that the robot is simple to model and control, maneuverable, and robust to collisions. The propulsion architecture is described in detail along with a rigid body model for maneuvering control. A novel valve Pulse Width Modulation (PWM) controller is used to achieve heading control, and the controller performance is confirmed with both simulation and experiments. Operability of the robot including turning and diving performance was confirmed through experiments.

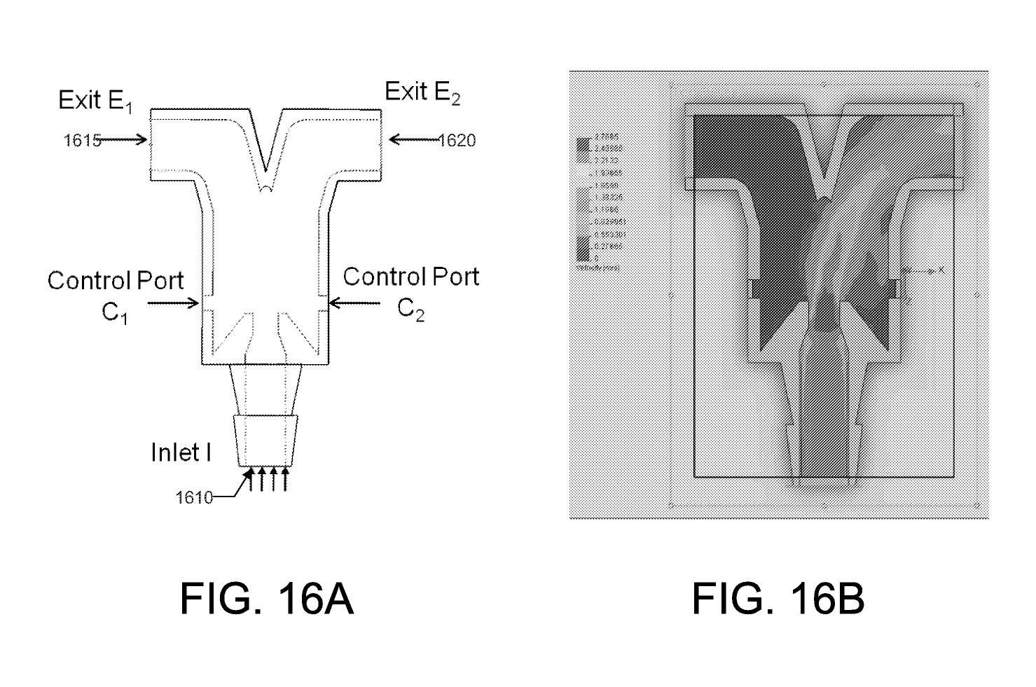

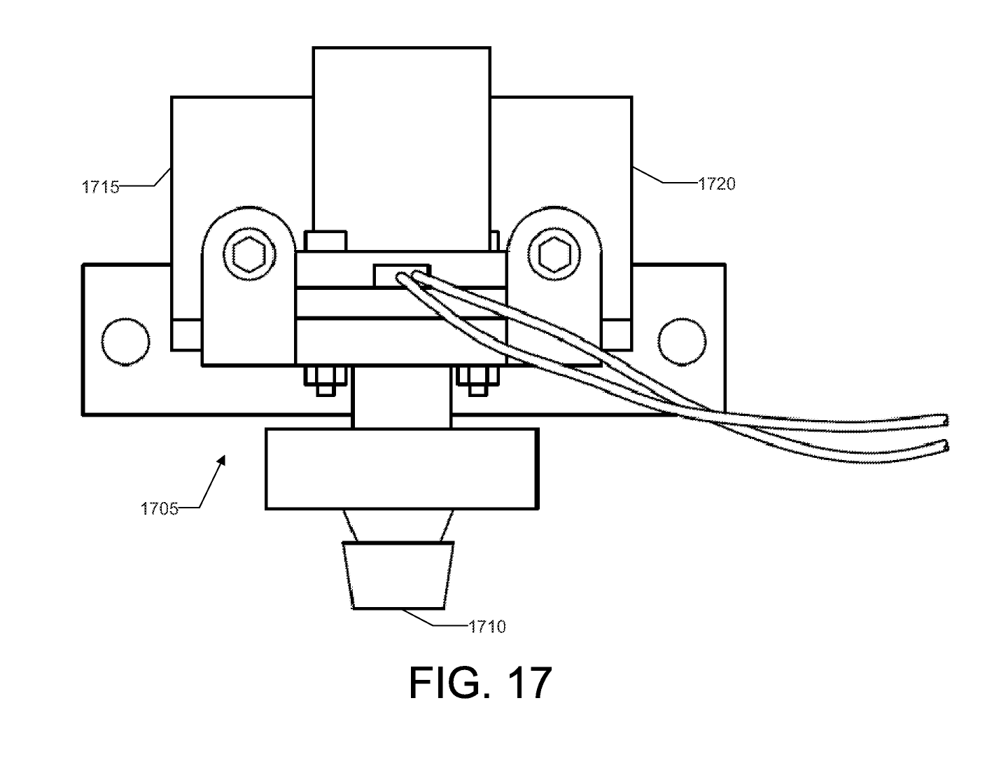

In a specific implementation, a robot is provided that combines a powerful propeller with a pump-valve system that enables high maneuverability. In order to reduce size and improve turning performance, this specific implementation of the design does not include external stabilizers such as fins. Typically, the lack of external stabilizers, such as fins, will result in an underwater vehicle (e.g., robot) that is directionally unstable (e.g., yaw direction). In this specific implementation, however, systems, techniques, and algorithms are provided for an underwater robot that uses a propeller for propulsion and jets (rather than external stabilizers, e.g., fins) to help stabilize the robot. The pump-valve system is further described in the discussion accompanying FIGS. 16A-19.

In this specific implementation, a linear stabilizing controller is provided that does not require complicated flow sensors and instead simply uses angle and rate measurements. To prove operability, the linear controller was simulated and then implemented on a prototype robot. Results revealed that this stabilization method is effective in enabling straight motions and is also able to reject substantial disturbances.

Table A below provides a description of some of the variables that are discussed in this patent application.

TABLE A

| | |
|---|---|
| X | Position in X direction (Earth fixed reference frame) |
| Y | Position in Y direction (Earth fixed reference frame). |
| x | Position in x direction (vehicle fixed reference frame). |
| y | Position in y direction (vehicle fixed reference frame). |
| z | Position in z direction (vehicle fixed reference frame). |
| u | Surge velocity. |
| v | Sway velocity. |
| w | Heave velocity. |
| p | Roll rate. |
| q | Pitch rate. |
| r | Yaw rate. |
| φ | Roll angle. |
| θ | Pitch angle |
| ψ | Yaw angle |
| β | Sideslip angle (directional angle of attack). |
| m | Mass of vehicle. |
| Iₓₓ | Centroidal moment of inertia about x axis. |
| I_{yy} | Centroidal moment of inertia about y axis. |
| I_{zz} | Centroidal moment of inertia about z axis. |
| Xₚᵣₒₚ | Force in x direction from propeller. |
| Y_{J1} | Force in y direction associated with Pump 1. |
| Y_{J2} | Force in y direction associated with Pump 2. |
| −Xᵤ | Added mass associated with translations in surge (x) direction. |
| −Yᵥ | Added mass associated with translations in sway (y) direction. |
| −Z_{w} | Added mass associated with translations in heave (z) direction. |
| −Kₚ | Added inertia associated with rotations about (x) axis. |
| −M_{q} | Added inertia associated with rotations about (y) axis. |
| −Nᵣ | Added inertia associated with rotations about (z) axis. |
| −Xᵤᵤ | Drag force associated with translations in surge (x) direction. |
| −Yᵥᵥ | Drag force associated with translations in sway (y) direction. |
| −Z_{ww} | Drag force associated with translations in heave (z) direction. |
| −Kₚₚ | Drag moment associated with rotations about (x) axis. |
| −M_{qq} | Drag moment associated with rotations about (y) axis. |
| −Nᵣᵣ | Drag moment associated with rotations about (z) axis. |
| I_{z} | Total moment of inertia associated with rotations about the z |
| | axis. |
| M_{y} | Total inertia associated with translations in surge y axis. |
| Δm | Difference in added masses in y and x directions. |
| c | Jet coupling coefficient. |
| N_{M} | Munk moment (xy plane). |
| N_{Fin, L} | Moment about the z axis caused by fin lift. |
| N_{Fin, D} | Moment about the z axis caused by fin drag. |
| U_{∞} | Free stream velocity. |
| U_{C} | Cruising speed in surge (x) direction. |
| K_{F} | Force constant for pump-jet system [N/V]. |
| L_{F} | x distance between output jet and center of mass. |
| γ | Stability metric. |

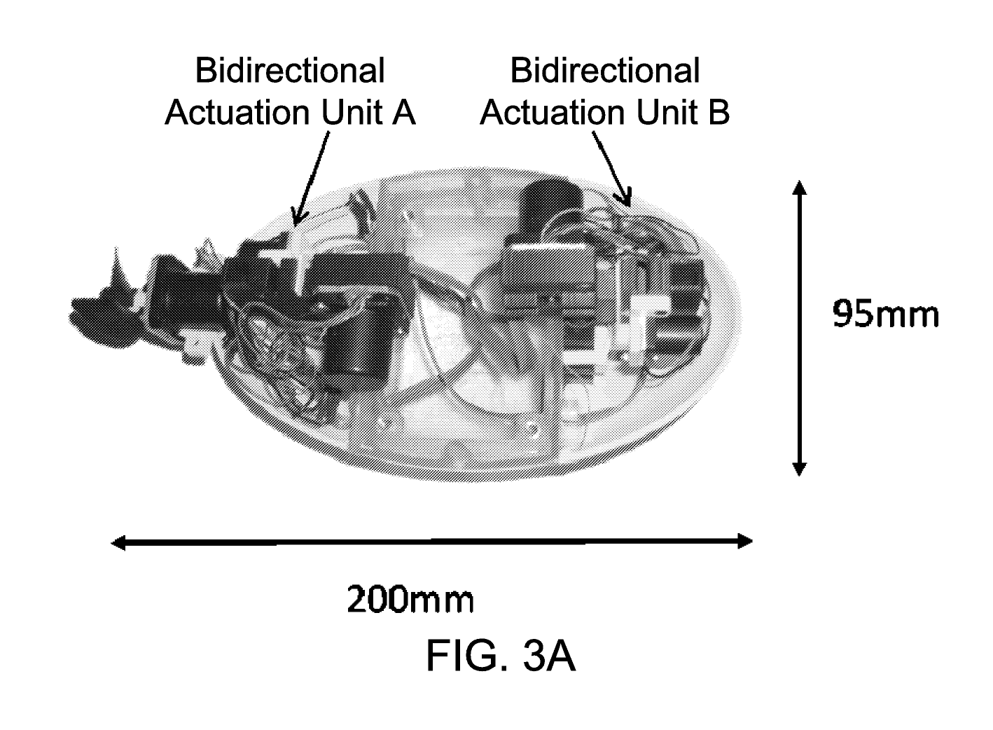

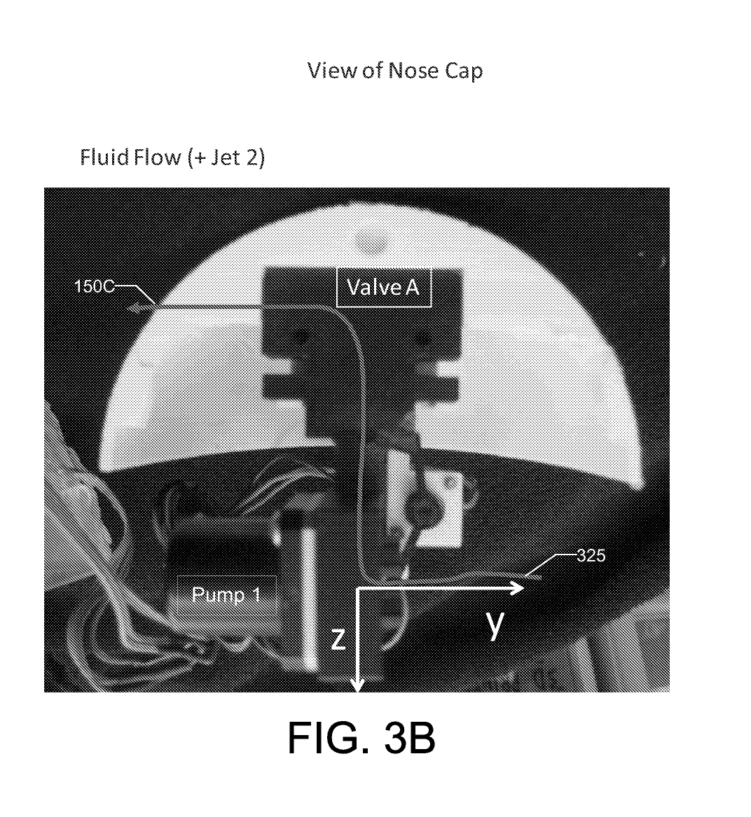

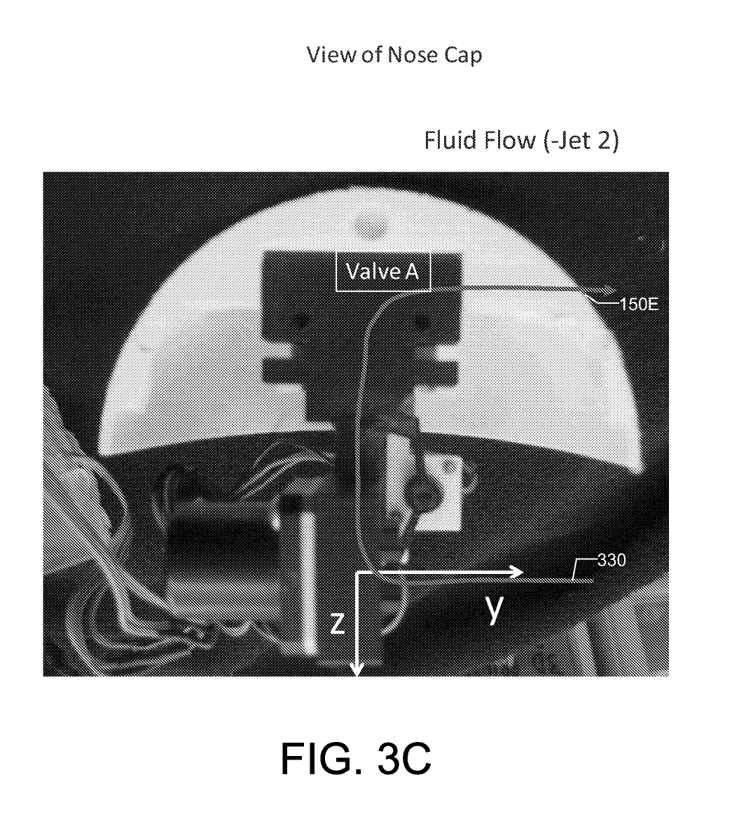

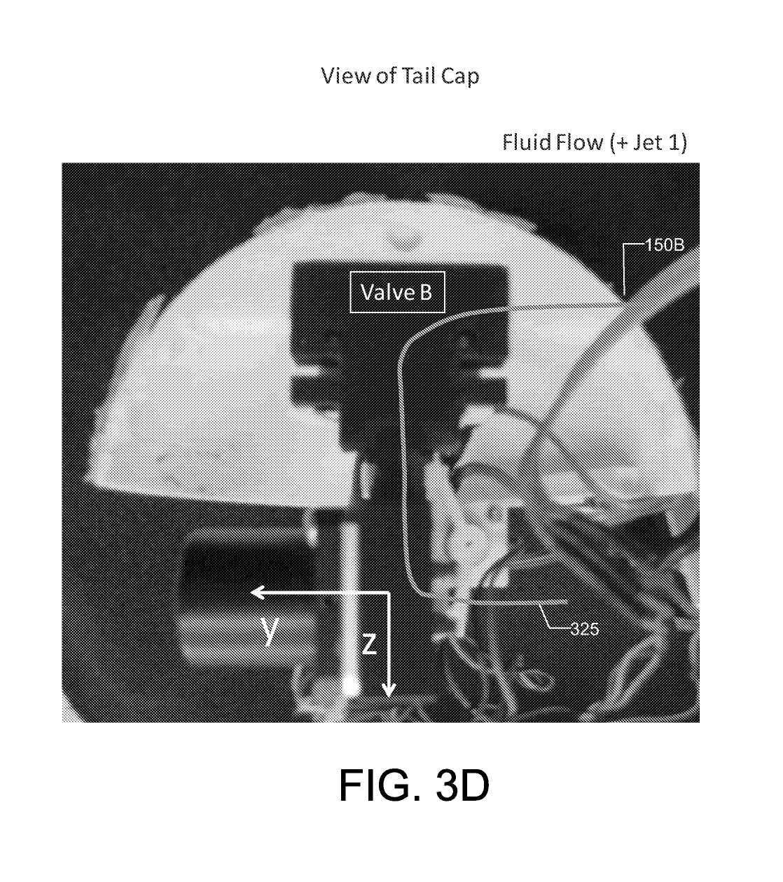

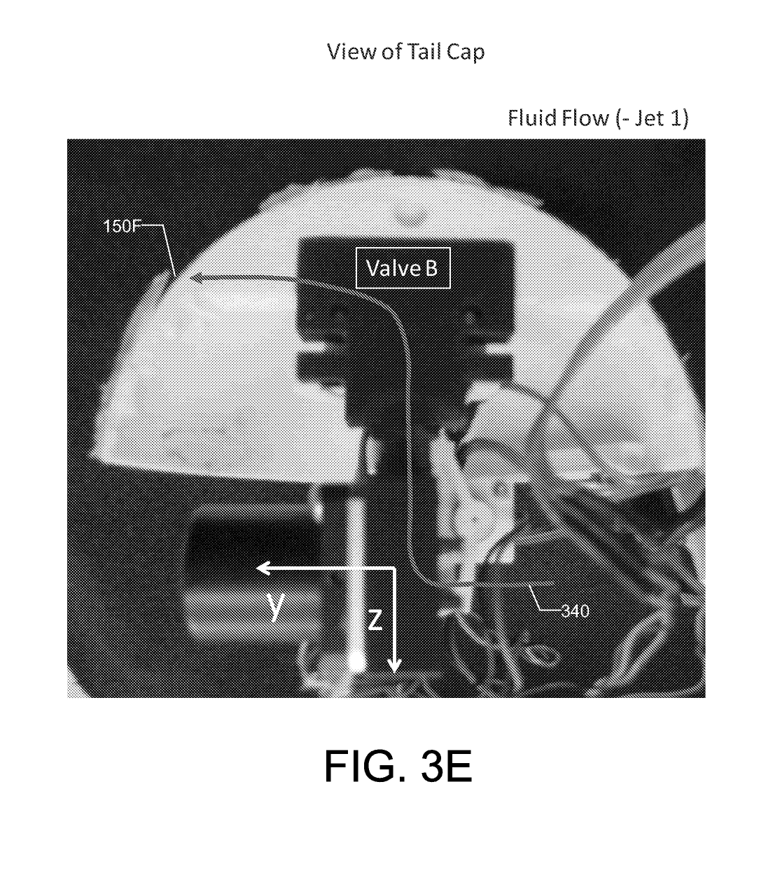

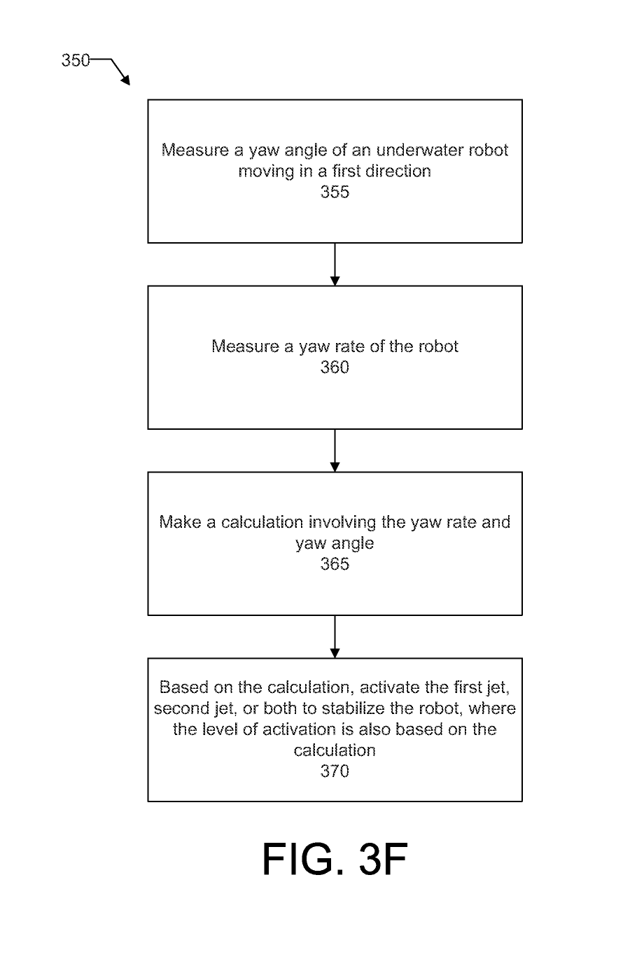

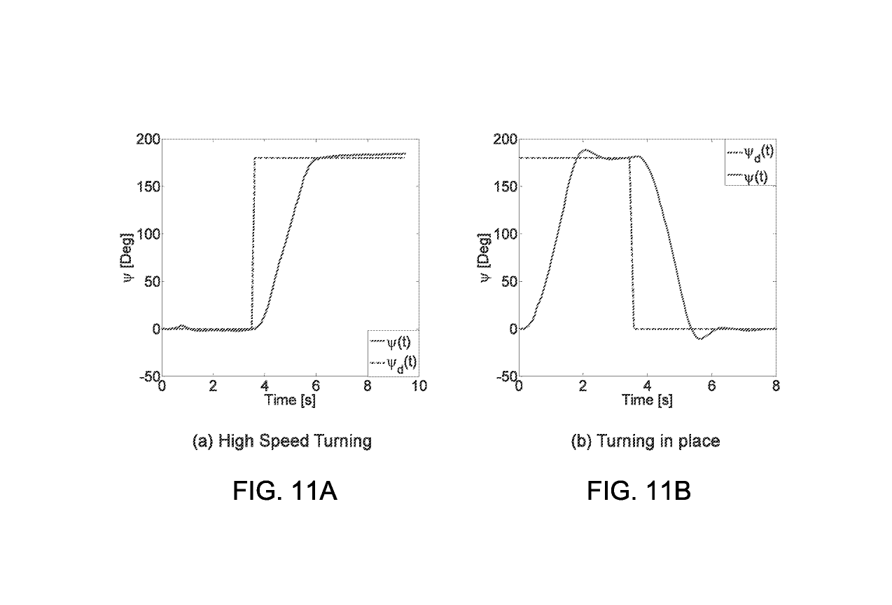

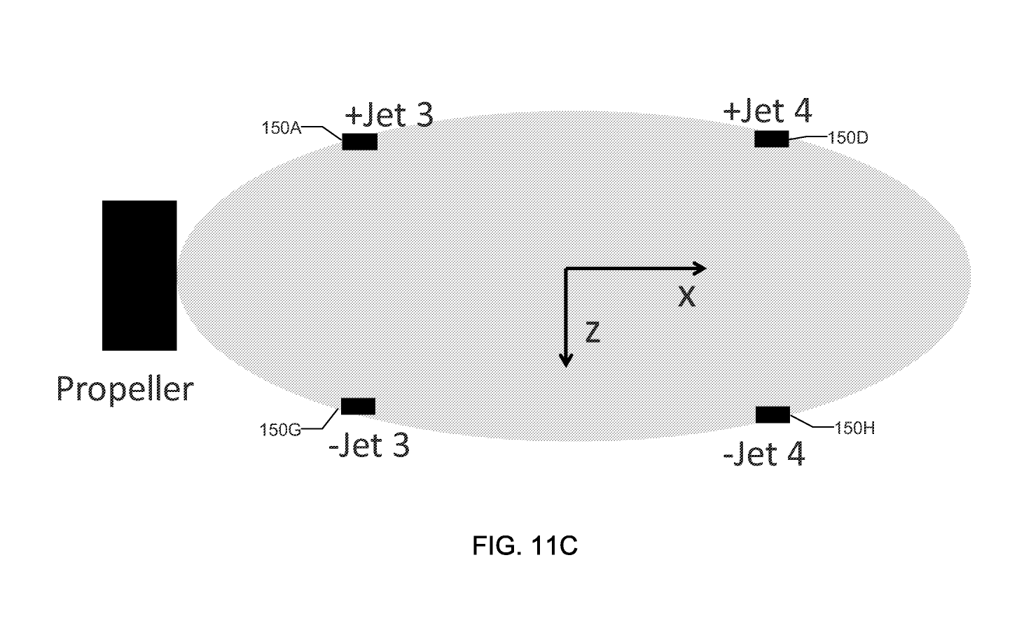

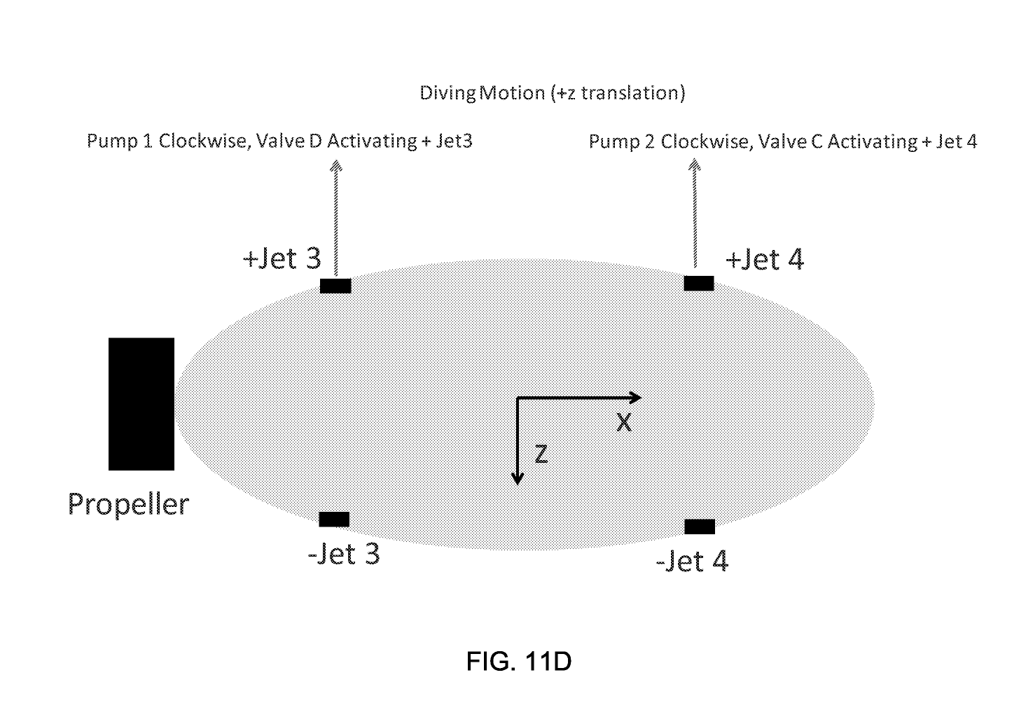

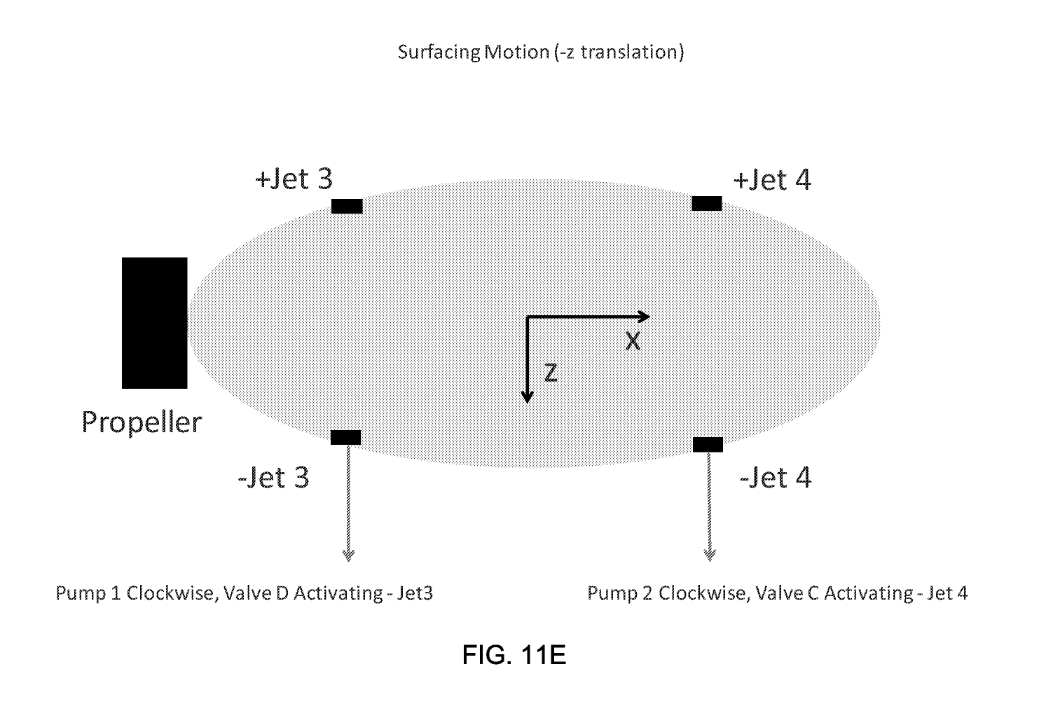

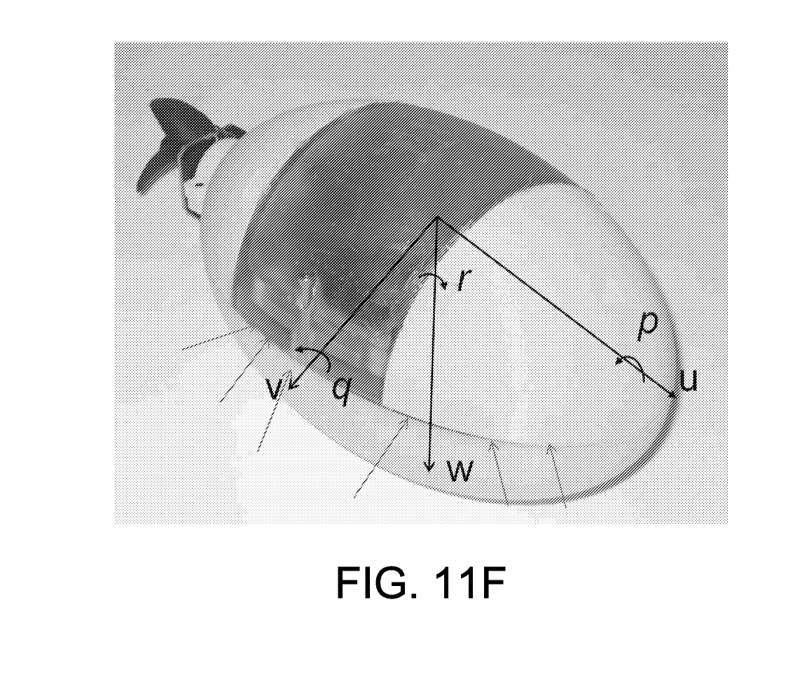

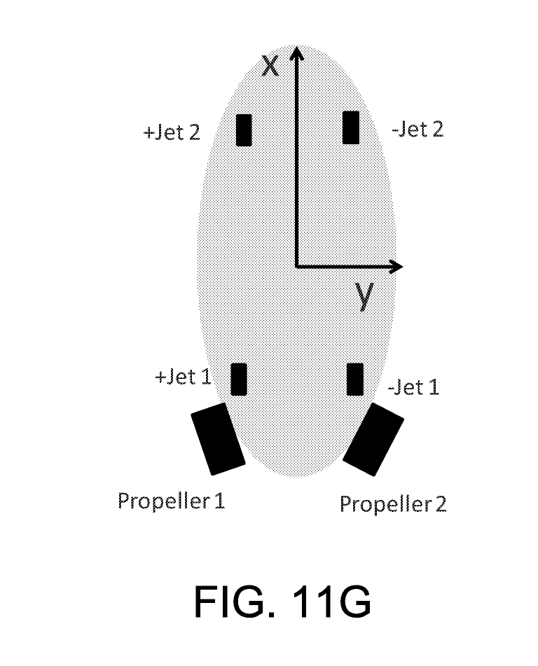

FIGS. 1C-D show top and bottom views, respectively, of a specific implementation of a smooth, highly maneuverable robot 145. FIGS. 11C-E show side views of the robot. This robot incorporates a jet-based stabilizing module. The module may also be referred to as a pump-valve maneuvering system. FIG. 3A shows a top view of the inside of another specific embodiment of a robot. This view shows a layout, positioning, arrangement, or configuration of the bidirectional actuation units of the jet-based stabilizing module. In this specific implementation, the first and second bidirectional actuation units are positioned lengthwise or along a longitudinal axis of the robot.

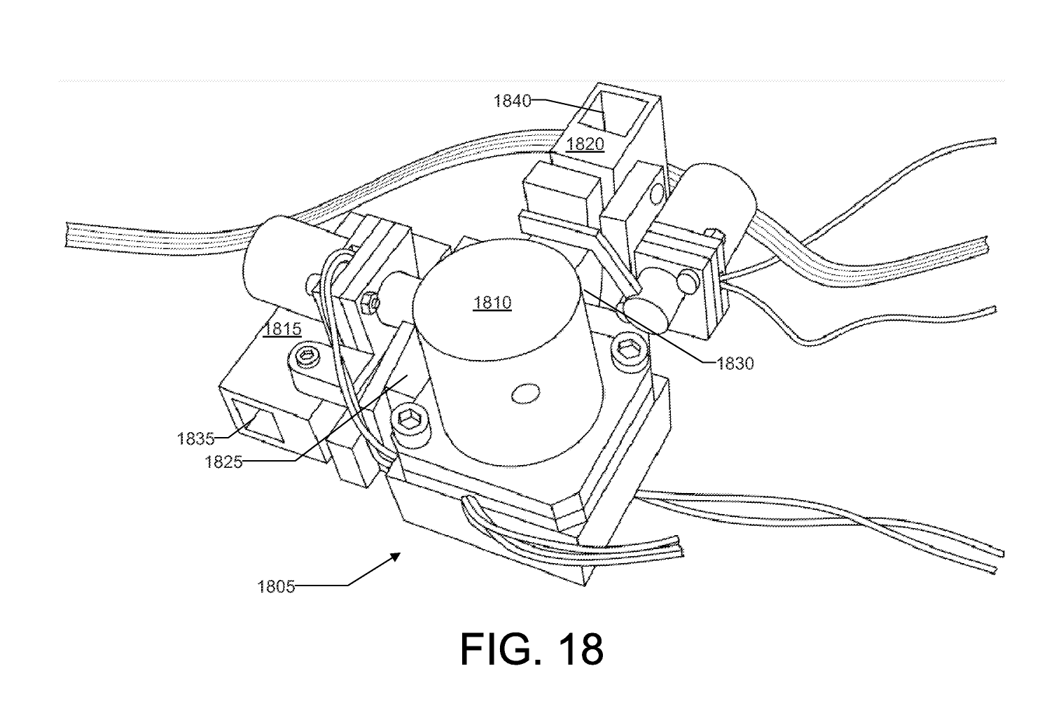

First bidirectional actuation unit A is positioned closer to a tail end of the robot than second bidirectional actuation unit B. Second bidirectional actuation B is positioned closer to a nose end of the robot than first bidirectional actuation unit A. The positioning helps to facilitate the elongated torpedo-shaped body of the robot. It should be appreciated that the positioning of the actuation units may vary depending upon factors such as the presence of other components (e.g., sensors or measuring instruments), desired body shape, and so forth. FIG. 3A further shows some dimensions for this specific embodiment of the robot. It should be appreciated, however, that these dimensions can vary greatly and may be different from what is shown in FIG. 3A. A more detailed view of a bidirectional actuation unit is shown in FIG. 18 and described in the discussion accompanying FIG. 18.

Referring now to FIGS. 1C-D, in this specific implementation, the vehicle is entirely or substantially smooth and symmetric on the outside (with the exception of the propeller in the rear). A pump jet maneuvering system is located entirely within the shell. Depending on the configuration of the valves and direction of rotation of the pump, the output jet can vary between four directions (+y, −y, +z, −z). In other words, in a specific implementation, there can be first, second, third, and fourth directions. The first and second directions are opposite each other (e.g., positive y direction and negative y direction). The third and fourth directions are opposite each other (e.g., positive z direction and negative z direction). The first and second directions are perpendicular to the third and fourth directions. The 5th DOF, translation in the surge direction (+x, −x) is provided by a propeller in the rear of the vehicle. In other words, the propeller can provide movement in a fifth direction (positive x direction) and a sixth direction (negative x direction), opposite the fifth direction. The fifth and sixth directions are perpendicular to the first, second, third, and fourth directions.

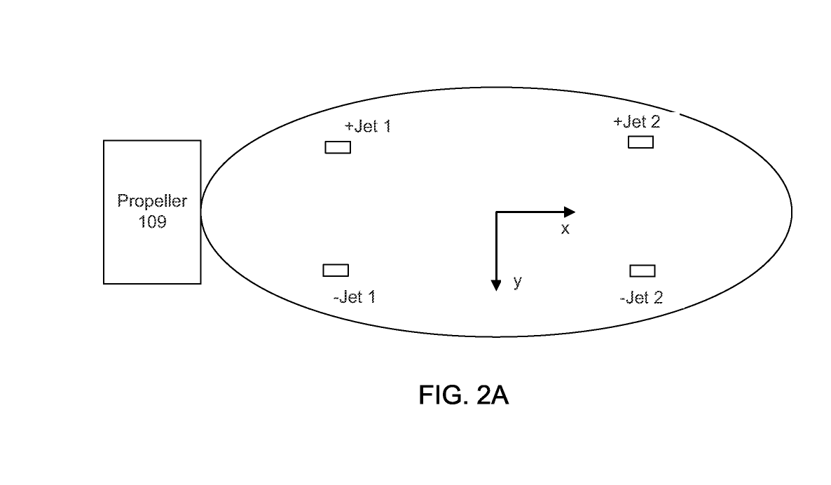

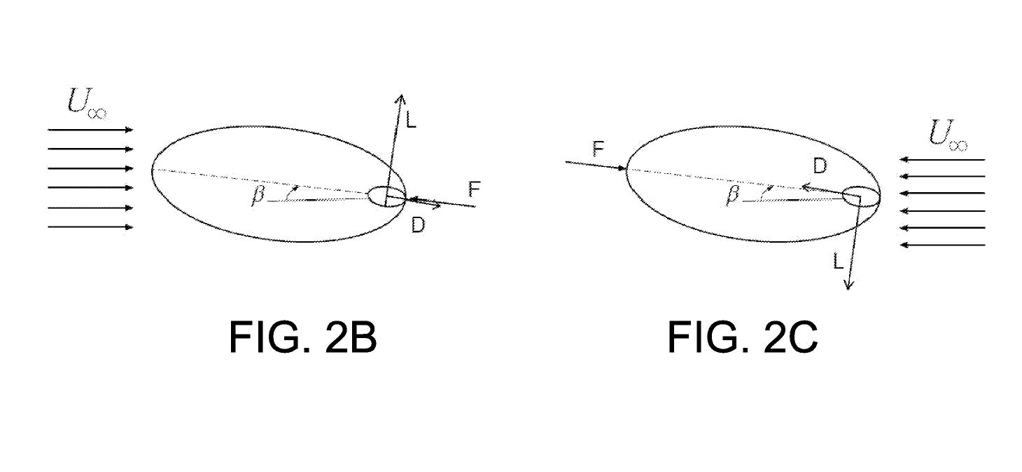

FIG. 2A shows a schematic of the propulsion components that were developed for the prototype robot. A marine robot having a smooth and streamlined shape allows for reduction of drag and ease of control. However, a common challenge with such robots is the presence of the Munk moment which tends to destabilize the vehicle in flow and rotate it to be perpendicular to the flow. Developing smooth, spheroidal vehicles is a challenging task due to the fundamental fluid mechanics. Smooth, streamlined robots are subjected to directional instability caused by the Munk Moment. For this reason, streamlined underwater vehicles often use fins at their rear to move their aerodynamic center backwards and therefore make them passively stable.

A common technique for dealing with the Munk moment is to use fins near the tail of the vehicle. The fins create a lift force that is also proportional to U²_{∞}. If the fins are placed far enough back the moment created by the lift force is enough to cancel out the Munk moment for all speeds. This makes the vehicle passively stable. However, fins can add substantial or extra size and weight making the robot less compact. Additionally, in cluttered environments, large fins can snag or collide with obstacles. Second, at large angles of attack, fins can add substantial induced drag that can inhibit the turning robot of the vehicle. Finally, while fins in the rear of the vehicle will stabilize the vehicle in one direction they will further destabilize the vehicle when the direction is reversed. Therefore a robot with fins would likely be required to turn around 180 degrees rather than simply being able to move in reverse. This limits the maneuverability and omni-directional properties of the robot. This phenomenon is illustrated with a diagram in FIGS. 2B and 2C. FIGS. 2B and 2C show how fins can provide stability in one direction (FIG. 2B) but instability in the other (FIG. 2C).

The Munk moment stems from pressure distributions around the ends of the vehicle and is a result of inviscid effects. Viscous effects result in the formation of vortices near the end of the body. These viscous effects tend to stabilize the vehicle to some extent. This effect occurs for both pitch and yaw. However, locating the center of mass below the center of buoyancy can passively stabilize the vehicle against pitching moments. This luxury does not exist for yaw. This patent application describes techniques to achieve yaw stabilization. Further, principles and aspects of the invention can be applied to pitch control in cases where the center of mass and the center of buoyancy are located very close to each other.

A closed form expression for the Munk moment exists and is provided in equation 1. Note that Yᵥ and Xᵤ are both negative, but the absolute vale of Yᵥ is larger.

N_{M}=U_{∞}² cos(β)sin(β)(−Y_{\dot{v}}+X_{\dot{u}}) (1)

Expressions for the viscous effects are more difficult to determine as they are reliant on experimental data. A reliable source for such data can be found in S. Hoerner, H Borst, “Fluid Dynamic Lift,” Mrs. Liselotte A. Hoerner, ch. 19, pp. 1-23, 1985. On a qualitative level the text describes how “fatter” bodies of revolution are more unstable and bodies that taper to a point are also the most unstable. Therefore, we will assume that the viscous stabilizing effects are small and ignore them for the sake of simplicity.

In a specific implementation, a unique pump-valve maneuvering system provides restoring forces and moments that will counter the Munk moment effect. U.S. patent application Ser. No. 13/887,239 (the '239 application), filed May 3, 2013, which is incorporated by reference along with all other references cited in this patent application, illustrates how the pump-valve system can be used to exploit the high performance of centrifugal pumps and achieve precision closed loop control. Using these maneuvering jets to also achieve stabilization means that no extra hardware such as fins are required for stabilization. For further details on the pump valve maneuvering system refer to A. Mazumdar, H. Asada, “A Compact Underwater Vehicle Using High-bandwidth Coanda-effect Valves for Low Speed Precision Maneuvering in Cluttered Environments,” Proceedings of the 2011 IEEE International Conference on Robotics and Automation, 2011 and A. Mazumdar, M. Lozano, A Fittery, H. Asada, “A Compact, Maneuverable, Underwater Robot for Direct Inspection of Nuclear Power Piping Systems,” Proceedings of the 2012 IEEE International Conference on Robotics and Automation, 2012.

The robot shown in in FIGS. 1C-D, includes first, second, third, fourth, fifth, and sixth openings 150A-F (FIG. 1C); and seventh, eighth, and ninth openings 150G-H (FIG. 1D). Openings 150A-H may be referred to as outlet or jet openings. Ninth opening 150I may be referred to as an inlet or intake opening. A coordinate system 147 is shown to help indicate the orientation of the robot.

Openings 150G-I are formed at various locations on the robot. In this specific implementation, the first opening is opposite the fourth opening. The second opening is opposite the sixth opening. The third opening is opposite the fifth opening. The seventh opening is opposite the eighth opening. The first opening is opposite seventh opening. The fourth opening is opposite the eighth opening. The first and seventh openings are closer to a propeller 152 or tail-end of the robot as compared to any of the other openings. The second and sixth openings are closer to the propeller than the third and fifth openings. The fourth and eighth openings are at a nose-end of the robot and are further away from the propeller as compared to any of the other openings.

A distance between the second and sixth openings is less than a distance between the first and fourth openings. That is, the distance between the first and fourth openings is greater than the distance between the second and sixth openings. A distance between the third and fifth openings is less than the distance between the first and fourth openings. That is, the distance between the first and fourth openings is greater than the distance between the third and fifth openings. A distance between the second and third opening may be the same as or different from a distance between the sixth and fifth openings. A distance between the second and sixth openings may be the same as or different from a distance between the third and fifth openings. In an implementation, openings 150A-H have the shape of a square. In various other implementations, the shape may be a rectangle, circle, oval, or other shape, or combinations of shape.

For the robot shown in FIGS. 1C-D, third opening 150C allows for the output of jet 2 in the positive y-direction. For example, FIG. 3B shows an inside view of the nose cap of the robot. A path 325 indicates a flow of fluid. The included coordinate system shows the orientation of the drawing relative to the robot. The first pump is positioned in the nose cap. The first pump generates a vacuum or suction that pulls the fluid into the pump. The fluid is then expelled as a jet through an opening of valve A and out third opening 150C.

Referring now to FIG. 1C, fifth opening 150E allows for the output of jet 2 in the negative y-direction. For example, FIG. 3C shows the inside view of the nose cap. This view is similar to the view shown in FIG. 3B. In FIG. 3C, however, a path 330 of the fluid is through an opposite opening of valve A and out fifth opening 150E.

Referring now to FIG. 1C, second opening 150B allows for the output of jet 1 in the positive y-direction. For example, FIG. 3D shows the inside view of the tail cap. A path 335 indicates a flow of fluid. The second pump is positioned in the tail cap. The second pump, similar to the first pump, generates suction to pull the fluid into the pump. The fluid is then expelled as a jet through an opening of valve B and out second opening 150B.

Referring now to FIG. 1C, sixth opening 150F allows for the output of jet 1 in the negative y-direction. For example, FIG. 3E shows the inside view of the tail cap. This view is similar to the view shown in FIG. 3D. In FIG. 3E, however, a path 340 of the fluid is through an opposite opening of valve B and out sixth opening 150F.

In an implementation, the jets of fluid expelled through openings 150A-H provide thrust to help resist destabilizing forces (e.g., Munk Moment). For example, the robot propeller provides forward travel (e.g., travel in an x-direction). In order to help the robot resist the destabilizing forces, the stabilizing module can generate the first jet, second jet, or both in the y-direction (negative y or positive y) to help the robot maintain travel in the forward or x-direction. The jets can also be used to help the robot quickly turn (e.g., turn left or turn right).

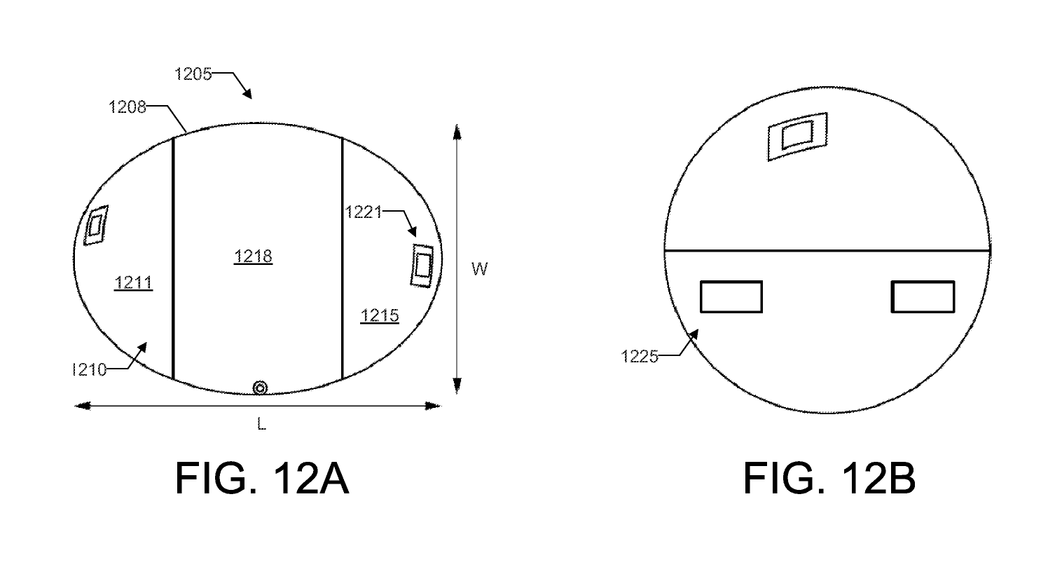

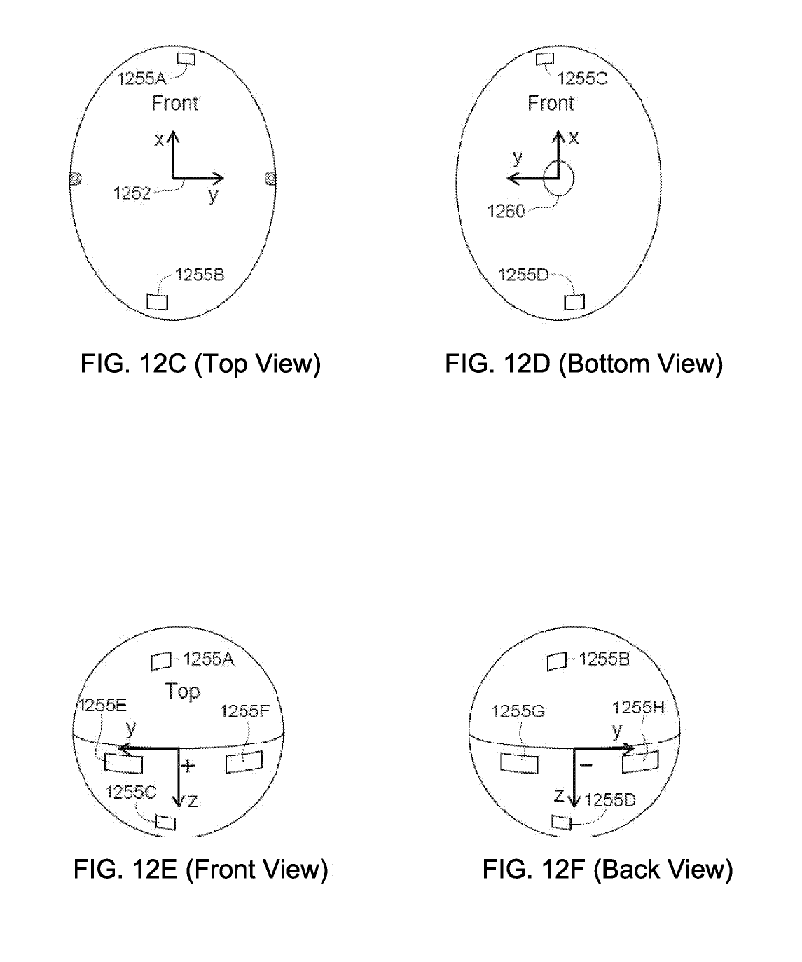

As discussed above, FIGS. 1C-D show a first specific embodiment of a robot that includes a pump-valve system and a propeller. FIGS. 12A-13 and 19-21 show a second specific embodiment of a robot that does not include a propeller. The pump-valve system includes a reversible centrifugal pump with 2 fluidic valves. As discussed, this combined system is referred to as a bidirectional actuation unit (BAU) and is described in detail in the '239 application and U.S. Provisional Patent Application 61/642,007, filed May 3, 2012. Those patent applications described using jets for maneuvering and propulsion. This patent application describes novel techniques for combining the BAU based maneuvering system with a torpedo shape. The torpedo shape is highly efficient, and propellers are a very efficient form of underwater propulsion. A specific embodiment of the underwater robot includes pump-valve maneuvering with a propeller-based design.

FIG. 3F shows a flow diagram 350 of an algorithm for controlling a specific embodiment of a robot having a pump-valve maneuvering mechanism and a propeller. Prototyping the robot included developing a full maneuvering model and using it to design a control system that acted as a replacement for passive stabilizers such as fins. Linearized models were used to design the controller, and experimental data was used to validate the design. Some specific flows are presented in this application, but it should be understood that the process is not limited to the specific flows and steps presented. For example, a flow may have additional steps (not necessarily described in this application), different steps which replace some of the steps presented, fewer steps or a subset of the steps presented, or steps in a different order than presented, or any combination of these. Further, the steps in other implementations may not be exactly the same as the steps presented and may be modified or altered as appropriate for a particular process, application or based on the data.

In brief, a step 355 includes measuring a yaw angle of an underwater robot moving in a first direction. A step 360 includes measuring a yaw rate of the underwater robot. A step 365 includes making a calculation involving the yaw angle and yaw rate. The measurements can be made via sensors as described above. In a specific implementation, a compass is used to measure the yaw angle. A step 370 includes, based on the calculation, activating a first jet, second jet, or both to stabilize the robot, where a level of activation is also based on the calculation.

More particularly, in a specific implementation, there is a controller having a processor for receiving sensor information and for causing control signals to be generated. There are first and second actuation units responsive to the controller processor control signals. The first and second actuation units are positioned inside the body. Each actuation unit includes a pump and two valves connected to the pump. As the propeller propels the robot, the controller causes jets of fluid outputted from the first and second actuation units to stabilize xy planar motions of the robot.

For example, referring now to FIG. 2A, in a specific implementation, the propeller provides a force to propel the robot in a first direction (e.g., x direction). The jets can be activated to help maintain travel in the first direction, e.g., steady the robot. Specifically, the first jet may be activated to output fluid in a second direction (e.g., positive y direction), or a third direction (e.g., negative y direction). The second jet may instead or additionally be activated to output fluid in a fourth direction (e.g., positive y direction), or a fifth direction (e.g., negative y direction).

Thus, if the controller detects that the robot is beginning to experience an undesired rotation due to effects such as the Munk Moment, the controller can activate one or both jets to help steady the robot. For example, if the controller detects that the robot is beginning to rotate in a clockwise direction, the controller can activate the second jet to output fluid in the fifth direction (negative y direction) to help resist the undesired clockwise rotation and maintain the robot's travel in the first direction. Conversely, if the controller detects that the robot is beginning to rotate in a counter-clockwise direction, the controller can activate the second jet to output fluid in the fourth direction (positive y direction) to help resist the undesired counter-clockwise rotation and maintain the robot's travel in the first direction. In some cases, the first jet may instead or additionally be activated to output fluid to help steady the robot.

In a specific implementation, the second and third directions are directly opposite each other. That is, an angle between the second and third directions may be about 180 degrees. The fourth and fifth directions are directly opposite each other. The second and third directions are parallel to the fourth and fifth directions. The second, third, fourth, and fifth directions are perpendicular, orthogonal, or normal to the first direction. That is, an angle between the first direction and the second, third, fourth, and fifth directions may be about 90 degrees.

However, this is not necessarily always the case. For example, another specific embodiment of the robot can include one or more angled jets. A jet opening on one side of the robot may be offset from a corresponding jet opening on the other side of the robot. In various specific implementations, the second direction may be not directly opposite the third direction. An angle between the second and third directions may be less than 180 degrees. For example, the angle may range from about 130 degrees to about 179 degrees. This includes, for example, 140, 150, 160, or 170 degrees. The angle may be less than 130 degrees. The fourth direction may not be directly opposite the fifth direction. An angle between the fourth and fifth direction may be less than 180 degrees. The second direction, third direction, or both may not be parallel to the fourth direction, fifth direction, or both. The second direction, third direction, or both may intersect the fourth direction, fifth direction, or both. The first direction may intersect the second, third, fourth, or fifth directions, but the first direction may not be perpendicular to the second, third, fourth, or fifth direction. That is, an angle between the first direction and the second, third, fourth, or fifth direction may not be 90 degrees. For example, the angle may be less than or greater than 90 degrees.

Angled jets can be used to provide various maneuverability and handling characteristics as desired. Generally, however, in order for the first and second jets to apply yaw moments about the vehicle center of mass, the second, third, fourth, and fifth directions will intersect the first direction. That is, the first direction will not be parallel with the second, third, fourth, or fifth directions. It should be appreciated, however, that a robot can include one or more other jets that are responsible for propelling the robot along the first direction. Thus, in this specific embodiment, there can be a jet that outputs fluid in a direction parallel to the first direction.

Both jets may be active at the same time. For example, to turn in place, the first and second jets may be active. Specifically, to turn or rotate in a clockwise direction, the first jet may be activated so that it outputs fluid in the third direction (e.g., negative y direction). The second jet may simultaneously or concurrently be activated so that it outputs fluid in the fourth direction (e.g., positive y direction). To turn in a counter-clockwise direction, the first jet may be activated so that it outputs fluid in the second direction (e.g., positive y direction). The second jet may simultaneously be activated so that it outputs fluid in the fifth direction (e.g., negative y direction).

As another example, to translate sideways, the first and second jets may be active. Specifically, to translate towards one side (e.g., towards the bottom of the drawing page), the first jet may be activated to output fluid the second direction (e.g., positive y direction). The second jet may simultaneously be activated to output fluid in the fourth direction (e.g., positive y direction). To translate towards an opposite side (e.g., towards the top of the drawing page), the first jet may be activated to output fluid in the third direction (e.g., negative y direction). The second jet may simultaneously be activated to output fluid in the fifth direction (e.g., negative y direction).

The level of activation depends on the control algorithm that is chosen. There can be threshold values for the controller “gains” that one of ordinary skill in the art can readily compute. The controller “gains” refer to the multiplicative factors that multiply the angle error and rate error in order to compute the jet signals. External or environmental factors can affect the amount jet force or thrust that is generated. For example, when the conditions include strong currents or highly turbulent water, a greater amount of jet force may be generated to help steady the robot as compared calm conditions.

In a specific implementation, the yaw angle and yaw rate are determined using sensors internal to the robot (e.g., inertial sensor). In another specific implementation, the yaw angle and yaw rate are determined by a component external to the robot. In this specific implementation, instead of the raw data, processed sensor signals are submitted to the processor. In a specific implementation, the calculation involving the yaw angle and yaw rate are performed by the robot. In another specific implementation, calculations are done outside of robot and the resulting outcome is sent to the controller to act upon, causing actuator units to be used.

Vehicle Maneuvering Model

Full Model

The full maneuvering model for a 6DOF rigid body vehicle such as an underwater vehicle or an aircraft is complex and nonlinear. In developing the maneuvering model, several key assumptions were made to simplify the nonlinear equations:

1. Inertia matrix was assumed to be diagonal (cross terms are zero) due to the symmetric nature of the design.

2. The dominant hydrodynamic forces were assumed to be from added mass, drag, and Munk moment. Due to the symmetry of the vehicle, added mass and drag cross terms are 0.

3. The dominant drag was assumed to be quadratic. This is based on the large Reynolds number (˜40,000).

4. The center of mass would be positioned slightly below the center of buoyancy to provide static pitch and roll stability.

5. Actuator dynamics were sufficiently fast to be neglected from initial analysis.

$$m [ \frac{d u}{d t} + qw - rv ] = {X}_{prop} + {X}_{\dot{u}} \frac{d u}{d t} + {X}_{uu} u \vert u \vert \\ m [ \frac{d v}{d t} + ru - pw ] = {Y}_{\dot{v}} \frac{d v}{d t} + {Y}_{vv} v \vert v \vert + {Y}_{J 1} + {Y}_{J 2} \\ m [ \frac{d w}{d t} + pv - qu ] = {Z}_{\dot{w}} \frac{d w}{d t} + {Z}_{ww} w \vert w \vert \\ {I}_{xx} \dot{p} + ( {I}_{zz} - {I}_{yy} ) rq = {K}_{\dot{p}} \frac{d p}{d t} + {K}_{pp} p \vert p \vert \\ {I}_{yy} \dot{q} + ( {I}_{xx} - {I}_{zz} ) pr = {M}_{\dot{q}} \frac{d q}{d t} + {M}_{qq} q \vert q \vert \\ {I}_{zz} \dot{r} + ( {I}_{yy} - {I}_{xx} ) pq = ( - {Y}_{J 1} + {Y}_{J 2} ) {L}_{F} + {N}_{\dot{r}} \frac{d r}{d t} + {N}_{rr} r \vert r \vert + {N}_{M} \qquad ( 2 )$$

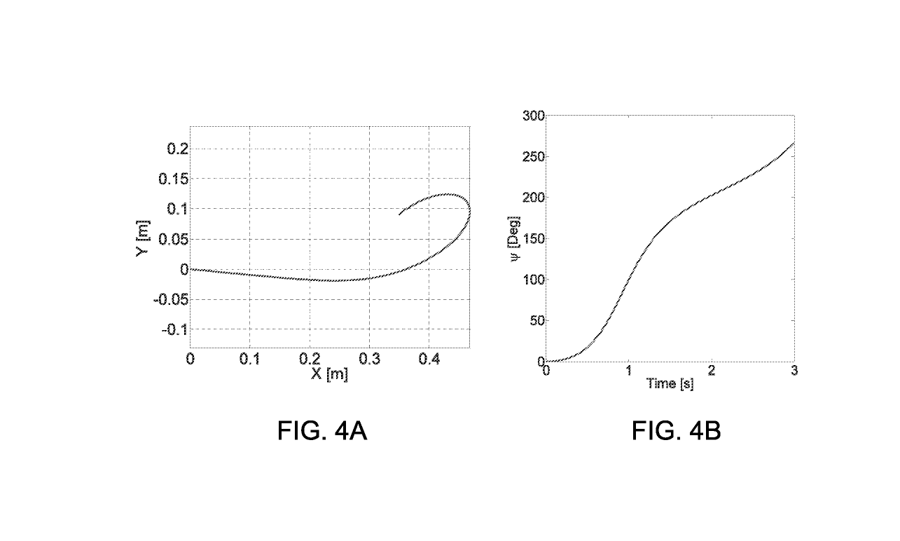

The added mass and drag coefficients were developed using simplified shapes as well as the tables provided in J. Newman; “Marine Hydrodynamics”, MIT Press, ch. 4, pp. 147, 1977. A simulation was performed to verify the validity of the physical model and to illustrate the nature of the instability. The robot was assumed to start from rest and then commanded to move in the x direction. A small perturbation to the sideslip angle was provided. The simulation results are provided in FIGS. 4A-B. Note how the yaw angle slowly increases and then eventually causes the robot to spin. This is due to the robot slowly accelerating until reaching a speed where the Munk moment becomes substantial. These results qualitatively matched experimental observations.

Linearized Model

While the full governing equations are coupled and nonlinear, linear control techniques provide a good starting point for controller design. We begin by finding the linearized version of the dynamic equations. We linearize about a longitudinal trim state with the vehicle moving with a cruising surge velocity of U_{C}. This means that the nominal surge velocity, u, is set to U_{C}. The remainder of the velocities and angles are assumed to be nominally zero. The resulting equations for surge, sway, and yaw are provided. Note that the script Δ is used to denote the difference between the linearized result from the full value. Also note that we use a common approximation for the sideslip angle Δβ.

$$\begin{matrix}Δ β = \frac{- Δ v}{{U}_{c}} & ( 3 ) \\ ( m - {X}_{\dot{u}} ) \frac{d ( Δ u )}{d t} = 2 {X}_{uu} {U}_{c} \vert Δ u \vert & ( 4 ) \\ ( m - {Y}_{\dot{v}} ) \frac{d ( Δ v )}{d t} = - {mU}_{c} Δ r + Δ {Y}_{J 1} + Δ {Y}_{J 2} & ( 5 ) \\ ( {I}_{zz} - {N}_{\dot{r}} ) \frac{d ( Δ r )}{d t} + {U}_{c} Δ v ( - {Y}_{\dot{v}} + {X}_{\dot{u}} ) = ( Δ {Y}_{J 1} - Δ {Y}_{J 2} ) {L}_{F} & ( 6 )\end{matrix}$$

We approximate the pump jet system as a linear system with zero dynamics. We use K_{F} to represent the transformation between the voltage input and the force output.

Yᵢ=K_{F}V₁ (7)

The planar maneuvering model can be rewritten in state space form where our states includes Δv, Δr, respectively. We neglect the u direction because it can be decoupled from the sway-yaw dynamics. Also, since we would like to achieve heading control we include a third state, the yaw angle Δ φ. The inputs to the system will be the control voltages ΔV₁ and ΔV₂. Our output of interest is the heading angle Δ φ.

$$\frac{d}{d t} [ \begin{matrix}Δ v \\ Δ r \\ Δ ψ\end{matrix} ] = [ \begin{matrix}0 & \frac{- {mU}_{c}}{m - {Y}_{\dot{v}}} & 0 \\ \frac{- {U}_{c} ( - {Y}_{\dot{v}} + {X}_{\dot{u}} )}{{I}_{zz}} - {N}_{\dot{r}} & 0 & 0 \\ 0 & 1 & 0\end{matrix} ] [ \begin{matrix}Δ v \\ Δ r \\ Δ ψ\end{matrix} ] + [ \begin{matrix}\frac{{K}_{F}}{m - {Y}_{\dot{v}}} & \frac{{K}_{F}}{m - {Y}_{\dot{v}}} \\ \frac{- {K}_{F} {L}_{F}}{{I}_{zz}} - {N}_{\dot{r}} & \frac{{K}_{F} {L}_{F}}{{I}_{zz}} - {N}_{\dot{r}} \\ 0 & 0\end{matrix} ] [ \begin{matrix}Δ {V}_{1} \\ Δ {V}_{2}\end{matrix} ] \qquad ( 8 )$$

One thing to immediately note from the state space model is the coupling between the sway velocity, v, and the yaw angle φ. This unusual coupling is a result of the sideslip angle. Note that if there were no jets pointing along the y direction, the system would be uncontrollable. Many streamlined robots have 2 propeller thrusters at the rear which can provide moments but not sway forces. The ability of our design to provide forces in the y direction is an unusual feature that in this case is desirable for linear control.

Closed Loop Control

Linearized Model Response

A common approach to controller design is to use the aforementioned state space model and incorporate full state feedback. Common techniques would be to use either a Linear Quadratic Regulator (LQR) or a pole placement technique. However, while feedback on φ and r is simple using inertial sensors, measuring v is more difficult. Sensors such as pitot tubes can be used, but this adds size, complexity, and can affect the external shape of the robot. Therefore, a controller based only on feedback on φ and r was designed. While this reduces the performance, it makes implementation much more straightforward. In order to simplify the equations the following simplifications were used.

I_{Z}=I_{zz}−N_{\dot{r}} (9)

m_{Y}=m−Y_{\dot{v}} (10)

Δmₐ=−Y_{\dot{v}}+X_{\dot{u}} (11)

Additionally, in order to simplify the controls problem into a single input single output (SISO) system, a variable called the jet coupling coefficient, c is defined. The jet coupling coefficient is used to relate ΔV₁ and ΔV₂, where c is a positive number between 0 and 1. The value of c can be tuned to change the open loop dynamics.

ΔV₂=−cΔV₁ (12)

By combining these expressions along with the linear state space model in equation 8 we can generate a SISO transfer function between the heading angle Δ φ and the jet voltage ΔV₁.

$$\frac{Δ ψ ( s )}{Δ {V}_{1} ( s )} = - \frac{{K}_{F} ( {sL}_{F} ( 1 + c ) + \frac{Δ {m}_{a} {U}_{c}}{{m}_{Y}} ( 1 - c ) )}{s ( {I}_{T} {s}^{2} - \frac{m Δ {m}_{a}}{{m}_{Y}} {U}_{c}^{2} )} \qquad ( 13 )$$

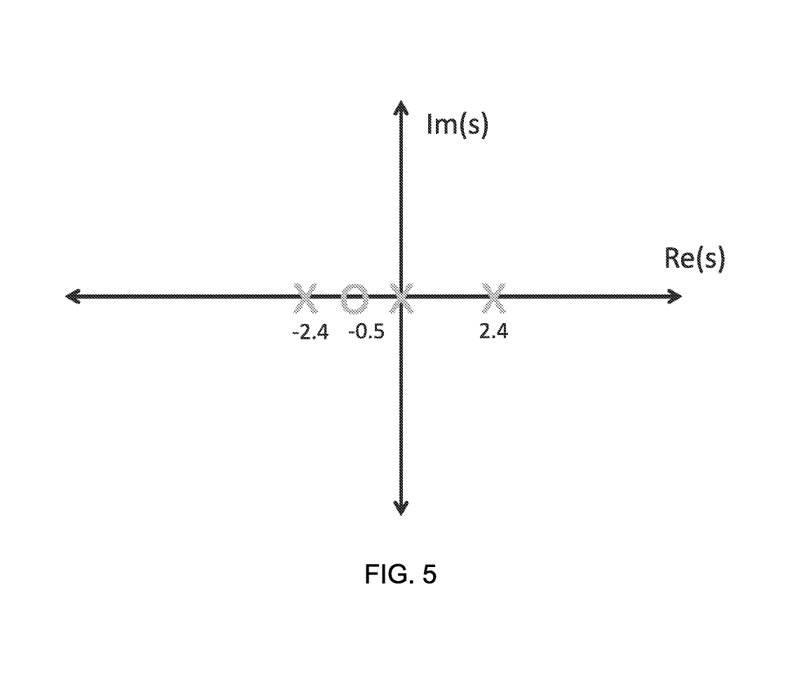

FIG. 5 shows the SISO pole locations for the linearized model. Note how the system has three poles, one at the origin, and two symmetrically placed about the imaginary axis. This means that one of the poles is unstable which corresponds with the full nonlinear system. Also note the presence of the zero in the transfer function. By adjusting the value of c the location of the zero can be changed or eliminated entirely.

Developing the model further included using parameters that match the physical robot prototype shown in FIG. 1C. The equation for the PD controller is provided below. The relevant physical parameters are summarized in Table B below. It should be appreciated that the values shown in Table B are based on the specific robot prototype shown in FIG. 11F that was developed and tested to confirm operability. These values may be different in other implementations.

ΔV₁(s)=(φ_{d}(s)−φ(s))(Kₚ+K_{d}s)

TABLE B

| Parameter | Value | |
|---|---|---|
| m | 0.80 | [kg] |
| Xᵤ | −0.24 | [kg] |
| Xᵤᵤ | −3.5 | [kg/m] |
| Yᵥ | −0.48 | [kg] |
| Yᵥᵥ | −3.17 | [kg/m] |
| I_{zz} | 0.0015 | [kg/m²] |
| Nᵣ | −0.00015 | [kg/m²] |
| Nᵣᵣ | −0.0006 | [kg/m²] |
| U_{c} | 0.25 | [m/s] |
| K_{F} | 0.125 | [N/V] |
| L_{F} | 0.038 | [m] |

Based on these values, the jet coupling value c was tuned to be 0.5. This means that the zero is located in the left half of the complex plane at s=−0.5. Lower values of increase the speed of the zero, but higher values of c increase the size of the restoring moment. Making c equal to 1 results in greatly reduced control authority because the actuators act symmetrically and do not act to directly reduce the sway velocity (Δv).

Controller Design

An examination of the pole zero diagram of the linearized model reveals that a simple proportional plus derivative (PD) controller could be suitable for stabilizing the system. We begin by placing the zero at s=−3.3. Note that a negative sign is included in the forward path so that we can still use positive gains. This is a result of our sign convention. We choose the proportional gain based on the saturation limits of the physical system. This ensures that the linear analysis will not break down during actual implementation.

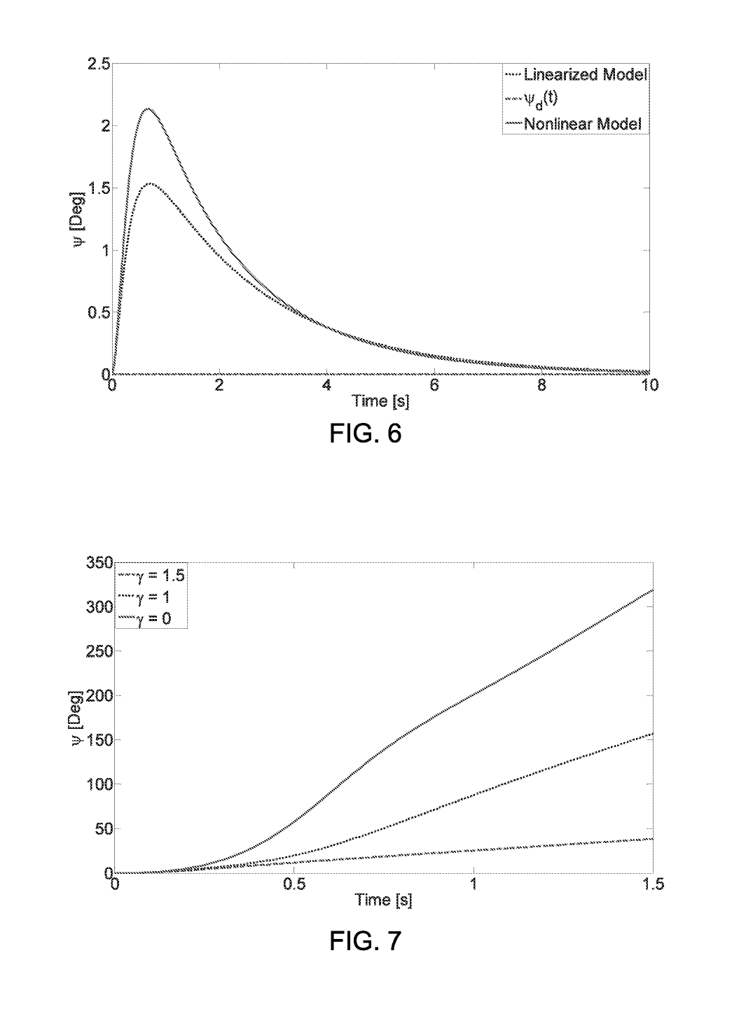

The controller performance was evaluated for an initial error in sideslip angle. This models the ability of the vehicle to stabilize itself if it is suddenly disturbed while moving at its cruising speed. As we have already shown, the vehicle without any feedback control immediately sees a divergence in its heading angle. FIG. 6 provides an illustration of the simulated controller response. Note how the controller is able to stabilize the robot in both the linear case as well as for the full nonlinear simulation.

Improved Performance from Open Loop Instability

There may be cases where directional instability can actually be exploited to improve performance. The use of closed loop control to achieve stability (stability augmentation) can be viewed as having two types of performance benefits. First, the weight and drag of passive stabilizing components can be reduced or eliminated. Second, passively stable designs can act sluggishly when commanded to change position or orientation. Studies on high performance aircraft have illustrated how these improvements can be achieved for Reduced Static Stability (RSS) aircraft. In this section we will discuss how RSS can be used to improve the performance of underwater vehicles.

In the case of underwater robots, the additional weight of fins is negligible as they can usually be made of light or neutrally buoyant materials. Of greater significance is their size. If the fins are too large they can limit the ability of the robot to enter highly confined or cluttered environments. We simulated a tailfin to stabilize the vehicle using a NACA 0015 airfoil. The fin was sized to make the robot only marginally stable. If we assume a simple square geometry, we can easily compute the length of the fin. Our calculations require a fin of a length scale that is nearly 25 percent of the vehicle diameter. These fins can perhaps be placed cleverly so that the net footprint of the vehicle does not change substantially, but the example still reveals that fins can contribute substantially to the size.

In addition, fins result in reduced performance not only due to the restoring force they provide, but also due to the induced drag that occurs at large sideslip angles. The variable is used to describe the moment provided by lift on the fin. Note that at small angles the drag moment from the fin, N_{Fin,D} is negligible. The metric y serves as an intuitive way to describe stability; if there are no fins, γ=0, and if the fins only achieve marginal stability, γ=1. Values of γ that are larger than 1 indicate passive stability.

$$γ = \frac{{N}_{Fin , L}}{{N}_{M}} \qquad ( 14 )$$

Maneuvering Performance

Several sample NACA 0015 fins were simulated for their ability to make the robot passively stable. NACA refers to the National Advisory Committee for Aeronautics. Lift and drag data was taken from publicly available tables (see, e.g., <http://www.aerospaceweb.org/question/airfoils/q0150b.shtml>). While these designs make the robot passively stable, they have other effects on maneuvering performance. A good test of maneuverability is through a “high speed turn test.” In this case the vehicle is moving at a large cruising speed and then tries to turn. The restoring forces and moments of the fins serve to restrict the ability of the vehicle to turn. This effect is illustrated in FIG. 7. Note how the vehicle without fins (γ=0) is able to exploit the instability and turn very rapidly compared to the passively stable vehicles.

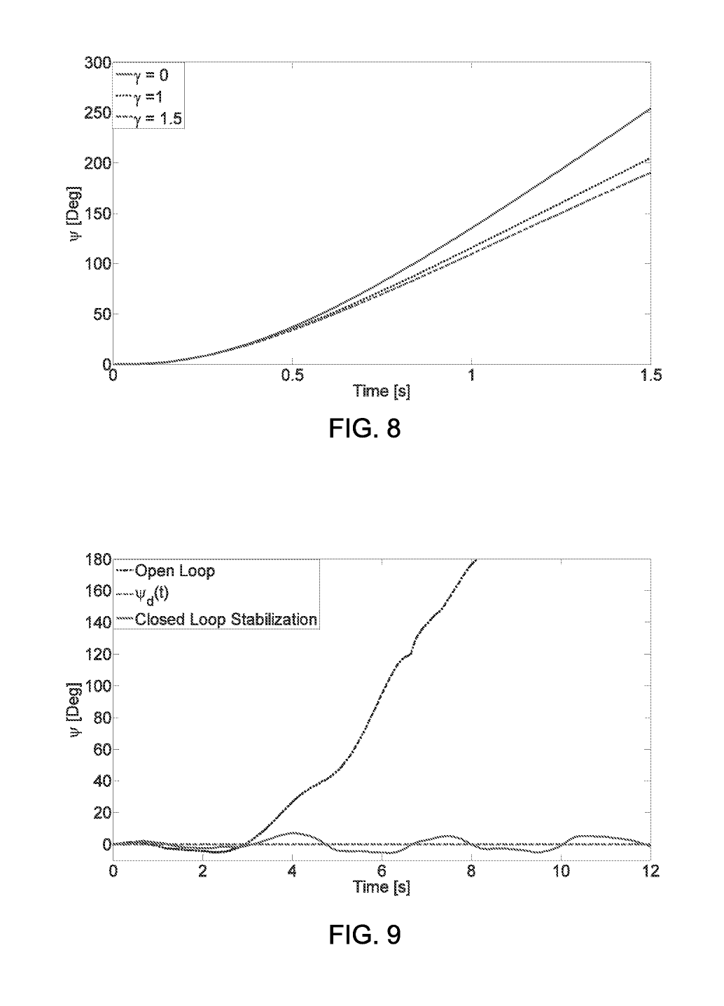

Another metric for maneuverability is low speed turning. This involves turning when the vehicle is already at rest. The ability to turn in place is important when moving within complex or confined regions. Underwater vehicles that rely on rudders for maneuvering have difficulty turning in place because the rudder lift force is dependent on forward velocity. The simulated results of a “turn in place test” are provided in FIG. 8. In these tests the passively stable robots do not fare as badly because the lift force is now very small. Note however that the open loop unstable robot still turns faster. This is mainly due to the drag force created by the fins.

Experimental Results

The prototype described earlier in this patent application was used to perform some preliminary experimental studies on the techniques discussed in this paper. The robot prototype weighs approximately 800 grams and is 170 centimers long. Stabilization using inertial sensors was implemented using a digital inertial measurement unit that used a gyroscope to estimate both yaw rate and yaw angle. While the integrated gyro does drift slowly, a compass can be used to compensate for this. For these preliminary experiments the time duration was short enough that gyro drift was not an issue. Tests were performed at the ocean engineering teaching facilities at The Massachusetts Institute of Technology (MIT). The controller design technique outlined in previous sections was used to design and implement the closed loop controller. The PD controller zero was placed at s=−3.3, and the gains match those in the simulation and the jet coupling coefficient, c, was set to 0.5.

Stabilization

Two basic experiments were performed. First, the feedback controller was implemented and examined for its ability to allow the robot to move straight. The robot forward speed was approximately 0.25 m/s. The results of this experiment are provided FIG. 9. As the data plot shows, the controller stabilizes the forward motion and enables the robot to move straight.

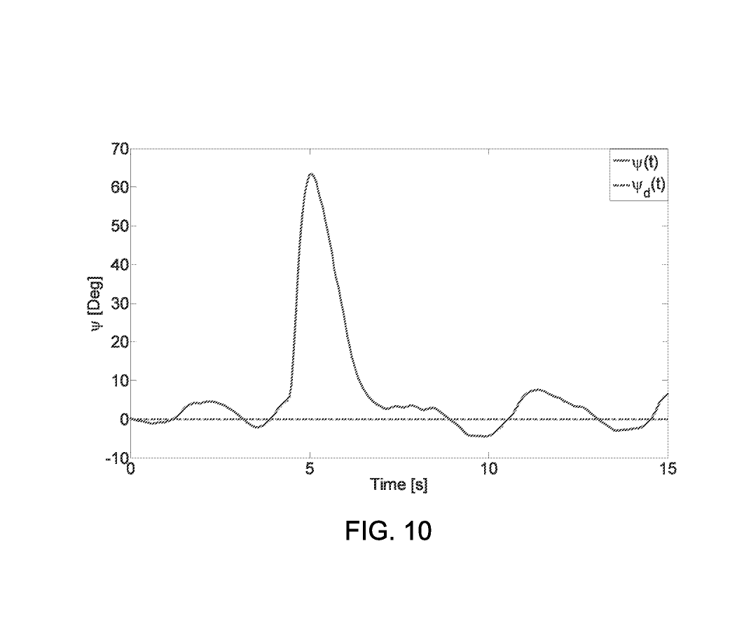

The second experiment involved disturbance rejection. The robot was commanded to swim straight and then subjected to a sizable perturbation. The ability of the robot to return to straight motion was examined. An illustration of these results is provided in FIG. 10. Note how the controller is able to respond to a disturbance that turns the vehicle 60 degrees as it is moving at full speed. The controller is able to quickly return the vehicle to straight motion.

Operating at neutral buoyancy in larger tanks can help to reduce low frequency oscillations including the effects of the vehicle pitching up and down near the water surface. These effects cause the vehicle to bob up and down. The prototype robot vehicle was allowed to operate very close to the water surface at slightly positive buoyancy. These bobbing motions can sometimes affect the propeller if it is lifted out of the water and can also cause oscillations that affect the controller.

Turning

A key feature of this type of design relates to turning ability. By making the vehicle smooth and symmetric, simulations have predicted superior turning performance for both high speed and stationary cases. We confirmed this with two experiments. The first was a high speed turn where the vehicle was allowed to move at full speed and then commanded to turn around completely. As FIG. 11A illustrates, the vehicle is able to turn around very quickly and tracks the heading angle quite well.

The second turning experiment was turning in place. The vehicle was allowed to remain at rest and then commanded to rotate in place. This is a common metric for underwater vehicles because low speed maneuvering is challenging for many types of designs. As FIG. 11B illustrates, the vehicle is able to turn while stationary and the controller tracks the heading angle very well. It is interesting to note that the same linear controller that was used to stabilize the high speed motions also functions quite well for stationary turning. Visual analysis confirmed that the vehicle is able to turn with very little translations.

This patent application described the development of a novel 5 DOF robot that combines a propeller with a pump-valve propulsion in order to achieve both high efficiency and high maneuverability. Due to the Munk moment, the vehicle is directionally unstable. The pump-valve system is used to achieve directional stability. Using the internal pump-valve system instead of external fins reduces the size of the vehicle and also has the potential to provide improved turning ability. Models for the robot and instability were outlined, and a linear control system was designed. The linear controller is based on using only angle and rate feedback and therefore avoids the complications associated with measuring sideslip angle or sway velocity. The linear technique was shown to stabilize the vehicle for both linearized models and full nonlinear models that include nonlinear drag, and actuator dynamics. Finally, the linear controller was implemented into the physical prototype with only small adjustments. The controller was shown experimentally to achieve both stable straight motions as well as substantial disturbance rejection capabilities.

FIGS. 11C-E show the diving and surfacing capabilities of a specific implementation of the robot. FIG. 11C shows a schematic diagram of a side view of the robot. A coordinate system is shown to indicate orientation. FIG. 11D shows a schematic diagram of the side view of the robot diving. FIG. 11E shows a schematic diagram of the side view of the robot surfacing.

Referring now to FIG. 11C, as discussed above, in a specific implementation, the robot includes a propeller to propel the robot in an x-direction. This robot includes first opening 150A, fourth opening 150D, seventh opening 150G, and eighth opening 150H. The first opening outputs a third jet of fluid in a sixth direction (e.g., positive z direction). The seventh opening outputs a fourth jet of fluid in a seventh direction (e.g., negative z direction). The fourth opening outputs a fourth jet of fluid in a ninth direction (e.g., negative z direction).

FIG. 11D shows the robot in a diving mode. In the example shown in FIG. 11D, the first pump is rotating clockwise (as viewed when looking at the pump face). The controller activates fourth valve D to output the third jet of fluid in the positive z direction. Similarly, the second pump is rotating clockwise (as viewed when looking at the pump face). The controller activates third valve C to output the fourth jet of fluid in the positive z direction. In other words, if pump 1 is rotating clockwise (when looking at the pump face), and pump 2 is clockwise (when looking at the pump face), the robot is in the diving mode and jets 3 and 4 are activated. Valve D is used to control jet 3. Valve C is used to control jet 4. This enables the robot design to adjust its depth.

FIG. 11E shows the robot in a surfacing mode. In the example shown in FIG. 11E, the first pump is rotating clockwise. The controller activates fourth valve D to output the third jet of fluid in the negative z direction. Similarly, the second pump is rotating clockwise. The controller activates third valve C to output the fourth jet of fluid in the negative z direction.

FIG. 11F shows a perspective view of another specific embodiment of a prototype robot that was developed. In this specific embodiment, fluid is allowed to enter through a gap between the top and bottom shells as shown by the arrows. This design did not include an inlet hole in the bottom. Rather, fluid (e.g., water) entered through the porous plastic and also through the sides of the vehicle. The bottom and top half were not sealed together, so fluid could enter the bottom half through these gaps. This design provided for a robot larger in size as compared to the prototype robot shown in FIGS. 1C-D.

FIG. 11G shows a top view of another specific embodiment of a robot. This robot includes two propellers. Each propeller is angled inward as shown in the figure. The control techniques described in this patent application can be used to stabilize the robot. For this robot design, propellers are modulated to maintain the vehicle orientation (rather than the pumps). Then the first and second pumps (powering jets 1 and 4) are used to move sideways, turn at low speeds, and dive. This system can allow the robot to move faster and more efficiently as compared to the robot designs where a single or no propeller is used. In some cases, however, it will be desirable to have a single propeller robot as shown in FIG. 1C. For example, a single propeller may be less expensive to manufacture as compared to a dual propeller robot because only one propeller needs to be purchased. Further, a single propeller design may be less likely to snag as compared to the dual propeller robot.

FIGS. 12A-13 and 19-21B show a second embodiment of an underwater vehicle or robot. This underwater robot is similar to the robot shown in FIGS. 1C-2A and 3A, but does not include a propeller. In this second embodiment, an underwater vehicle propulsion system is provided that allows a smooth, symmetric underwater robot to move with 5 degrees of freedom (DOF). Maneuvering forces and moments are provided by using internal pumps and valves to eject fluid jets through various exit ports. The degrees of freedom include surge, sway, heave, pitch, and yaw. In a specific embodiment, the vehicle is entirely symmetric and has no external appendages such as propellers or fins. The use of an internal propulsion system allows the robot to operate very quietly and create few disruptions to the surrounding fluid. These robots can be used for a variety of applications ranging from the inspection of water-filled piping structures, to exploration of underwater infrastructure and wildlife, just to name a few examples. In a specific embodiment, the robot is completely or substantially smooth yet capable of stable motions in 5 translations or rotations.

In a specific embodiment, a smooth spheroidal robot is capable of 5 degrees of freedom and has no external appendages such as propellers or fins. In this specific embodiment, the smooth outer shape and 5 degrees of freedom are achieved through the use of a pump-valve architecture based on retrofitted centrifugal pumps and fluidic valves. Angled jets are provided which enable translations in surge, sway, and allows the system to be stabilized through feedback control.

The development presented here introduces a combination of a novel design and closed loop control that overcomes the issue of instability and addresses the shortcomings of previous systems. In a specific embodiment, a jet arrangement is provided that enables the planar robot dynamics to be fully controllable. Linear control system design techniques are used to develop a closed loop controller capable of stabilizing the robot.

To prove operability, a prototype of a robot was fully built, tested, and verified to operate as intended. FIG. 12A shows a top view of a specific embodiment of a robot 1205 that was built as a prototype. FIG. 12B shows an end view of the robot shown in FIG. 12A. This prototype may be referred to as the Omni-Egg or Omni-Egg prototype. As shown in FIG. 12A, this specific embodiment of the robot includes a body or housing 1208 that define an interior space 1210. The body includes a first end 1211, a second end 1215, and an intermediate section 1218. The first and second ends are opposite each other. The intermediate section is between the first and second ends. A length L indicates a length of the robot. A width W indicates a width of the robot.

There are a set of openings 1221 on the body. The openings allow for the intake of a fluid, such as water, and the output of the fluid as jets which propel the robot through the fluid. More particularly, as shown in FIG. 12B, a first subset 1225 of the openings can be located at the first end. A second subset of the openings can be located at the second end.

FIGS. 12C-12F show views of another specific embodiment of a robot 1250 that was built as a prototype. This robot is similar to the robot shown in FIGS. 12A-12B, however, this robot does not include a separate intermediate section. FIG. 12C shows a top view of the robot. FIG. 12D shows a bottom view of the robot. FIG. 12E shows a front or first end view of the robot. FIG. 12F shows a back or second end view of the robot. A coordinate system 1252 has been included with the views to help indicate the orientation of the robot. This specific embodiment includes first and second ejection openings 1255A, B (FIG. 12C), third and fourth ejection openings 1255C, D (FIG. 12D), fifth and sixth ejection openings 1255E, F (FIG. 12E), and seventh and eighth ejection openings 1255G, H (FIG. 12F). There is an intake opening 1260 (FIG. 12D).

This example of the robot includes eight ejection openings and one intake opening. The number of openings, however, can vary depending on the factors such as the application of the robot, number of pumps, number of valves, desired movements (e.g., degrees of freedom), and so forth. For example, there can be fewer or more than eight ejection openings. There can be more than one intake opening. In a specific implementation, there are at least eight ejection openings.

Actuation units can be positioned inside the body that intake the fluid and eject the fluid as jets through the openings. For example, depending on the type of motion desired fluid may be outputted through the first end, second end, or both. Further discussion of the actuation units is provided below.

The body can further house other components of the robot such as one or more cameras (e.g., two cameras), controller, RF transmitter, RF receiver, antenna (e.g., for wireless operation), power source (e.g., battery), motor, switch, storage device (e.g., hard drive or flash memory for recording images), sensors (e.g., temperature sensor, or depth sensor), lights (e.g., light emitting diodes (LEDs)), measuring instruments, collection instruments, inspection sensors, and the like. The body can be designed to be watertight and may include seals, o-rings, gaskets, and the like.

In a specific embodiment, the body is made of plastic. Portions or sections of the body may include a transparent material so that a camera inside the body can capture images. For example, in a specific embodiment, the intermediate section includes a transparent material (e.g., transparent piece of plastic) for capturing images via the camera. Some examples of materials that the body may be fabricated or made from include polymers, nylon, rubber, carbon fiber, metal (e.g., steel, stainless steel, or titanium), glass, or combinations of these.

In a specific embodiment, the length of the robot is about 146 millimeters and a width of the robot is about 108 millimeters. The small size of the robot allows the robot to navigate through tight spaces. The dimensions of the robot, however, can vary greatly depending upon its application. For example, the length of the robot may be greater or less than 146 millimeters. The width of the robot may be greater or less than 108 millimeters.

As shown in FIG. 12A, in a specific embodiment, a shape of the robot includes a spheroid. A spheroid is a quadric surface obtained by rotating an ellipse about one of its principal axes; in other words, an ellipsoid with two equal (opposing) semi-diameters. In a specific embodiment, the shape is a prolate spheroid. A prolate spheroid has the shape of an ellipse that is rotated about its major axis. In this specific embodiment, the robot is symmetrical. A shape of the first end is the same as the shape of the second end. The shape of the first end can be a mirror image of the shape of the second end. The ends can be dome-shaped. A shape of a top half of the robot is the same as a shape of a bottom half of the robot.

The symmetry of the robot shape facilitates movement of the robot through the various directions or degrees of freedom. For example, having the shape of the first end being the same as the shape of the second end facilitates the robot's movement in a first direction (e.g., forward direction) and a second direction (e.g., reverse direction), opposite the first direction.

In this specific embodiment, the robot does not include an external propeller, fins, foils, stabilizing attachments, or other appendages that may break off or snag on obstacles. For example, an exterior surface of the robot may be smooth or substantially smooth, continuous, or uninterrupted by an appendage.

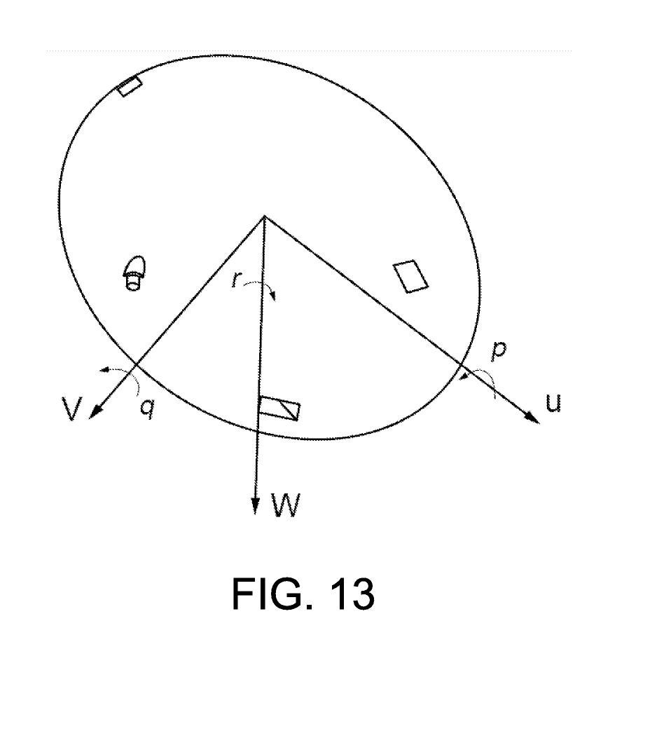

The smooth, spheroidal robot shown in FIGS. 12A and 12B is capable of 5 degrees of freedom and has a completely or substantially smooth outer shape. This design was achieved by using internal pumps which intake water and then eject or exhaust out pressurized jets. Fluidic valves are used to control the direction of the pressurized jets. Based on the jet direction, the robot can either purely translate in the “x” (surge) direction, the “y” (sway) direction, or the “z” (heave) direction. In addition the robot can purely rotate about either the “x” (pitch) axis or the “z” (yaw) axis. An illustration of the coordinate frame is provided in FIG. 13.

In other words, the surge motion may be unaccompanied or substantially unaccompanied by the sway, heave, pitch, and yaw motions. The sway motion may be unaccompanied or substantially unaccompanied by the surge, heave, pitch, and yaw motions. The heave motion may be unaccompanied or substantially unaccompanied by the surge, sway, pitch, and yaw motions. The pitch motion may be unaccompanied or substantially unaccompanied by the surge, sway, heave, and yaw motions. The yaw motion may be unaccompanied or substantially unaccompanied by the surge, sway, heave, and pitch motions.

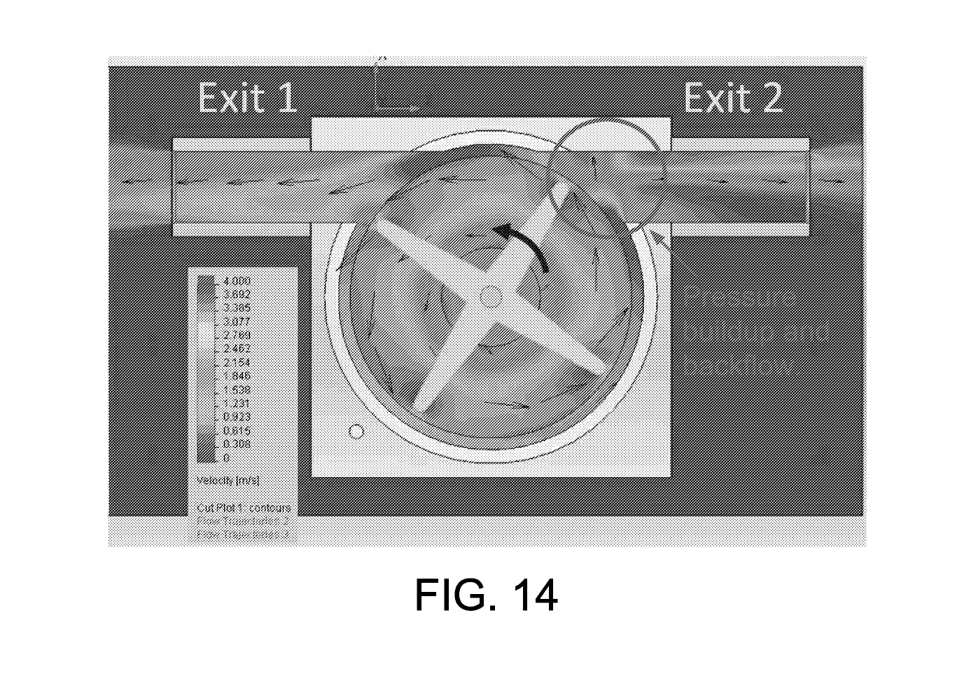

In a specific embodiment, an actuation unit includes a centrifugal pump for the propulsive component. Centrifugal pumps are advantageous because of their mechanical simplicity, availability at centimeter (cm) size scales, and the ease of use with electronic circuitry. However, one common issue with some centrifugal pumps is that they are not reversible. This means that the pump can only provide force in one direction and will need to be combined with a second one in order to achieve bi-directional forces. Ideally, the pump could be designed to provide forces in 2 directions 180 degrees apart. This would save substantial space and weight. An example of this geometry is provided in FIG. 14. The pump sucks water in through the plane of the page and then depending on the direction of rotation of the impeller will eject water through either Exit 1 or Exit 2. In this figure, the impeller is rotating counterclockwise and therefore is ejecting fluid through Exit 1. However, note that there is substantial flow out of Exit 2 as well. This “backflow” serves to degrade the performance of the pump by substantially reducing the output force.

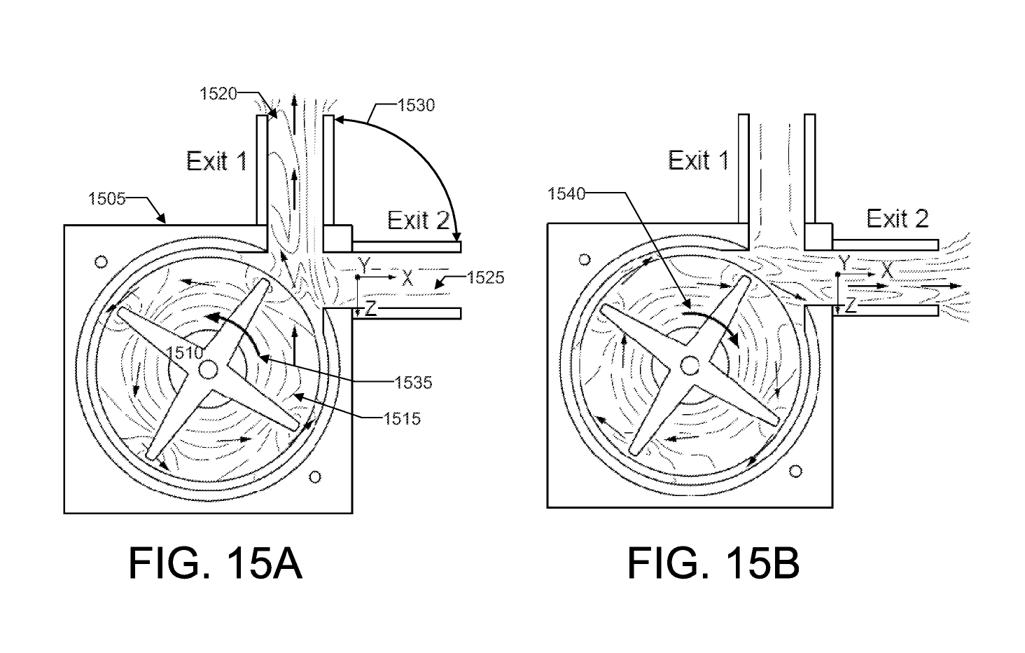

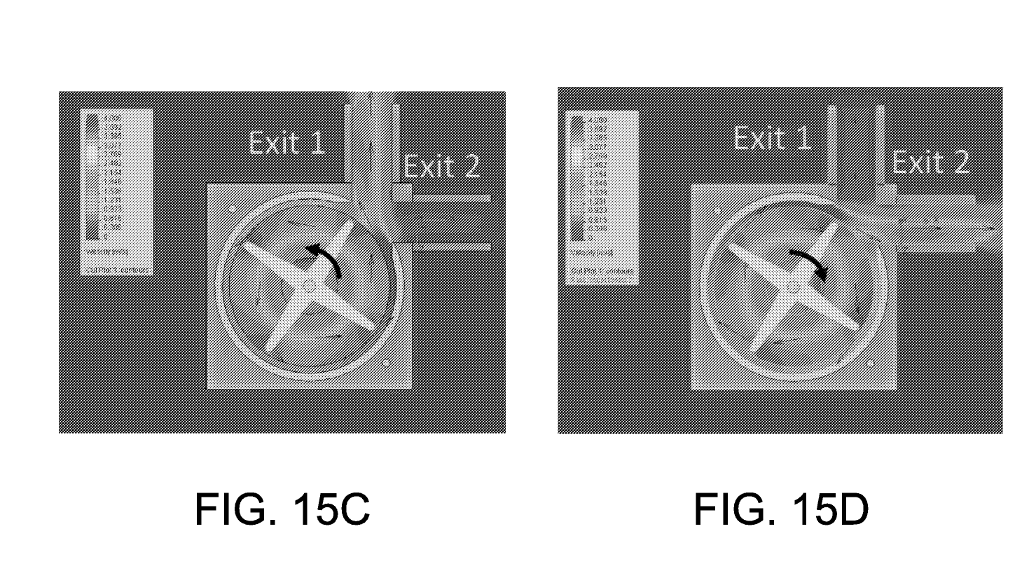

Applicants have discovered that by orienting the two exit ports adjacent to each other but 90 degrees apart, problems with backflow can be eliminated or reduced. This outlet design may be referred to a “90 degree retrofit.” FIG. 15A shows a schematic diagram of a pump 1505 of an actuation unit. A set of coordinate axis have been included with the figure to help indicate orientation. The pump includes an impeller 1510, a suction side 1515, a first exit (or first pressure side) 1520, and a second exit (or second pressure side) 1525.

In this specific embodiment, an angle 1530 between the first exit and the second exit is about 90 degrees. That is, the angle is a right angle. In the example shown in FIG. 15A, the impeller is rotating in a counter-clockwise direction 1535. As a result of the counter-clockwise direction, fluid will exit through the exit 1 (520). FIG. 15B shows a schematic diagram of the pump shown in FIG. 15A. In FIG. 15B, however, the direction of the impeller is reversed from the direction shown in FIG. 15A. That is, in FIG. 15B, a direction 1540 of the impeller is in a clockwise direction. As a result of the clockwise direction, fluid will exit through the exit 2 (525).

Computational Fluid Dynamic (CFD) illustrations of the 90 degree retrofit are provided in FIGS. 15C and 15D. FIG. 15C shows the CFD illustration for the pump direction shown in FIG. 15A. Note how in this case there is no or a reduced backflow out the second exit as compared to FIG. 14. In fact a small amount of suction occurs which further improves the force output. This approach was verified and shown to provide double the output force of the 180 degree pump. FIG. 15D shows the CFD illustration for the pump direction shown in FIG. 15B.

More particularly, in a specific embodiment, the unique capabilities of the robot are enabled by three components: retrofitted centrifugal pumps, use of fluidic valves to achieve bidirectional in-line forces, and the use of angled jets to achieve multi axis forces. Each of these three components will be discussed in greater detail below.

In a specific embodiment, fluidic valves that achieve bidirectional forces are provided. While the centrifugal pumps combined with the 90 degree retrofit provide substantial forces in 2 directions, the 2 directions are 90 degrees apart rather than the desired 180. This fact complicates vehicle design. One approach is to use elbows to redirect the flow. Elbows, however, can cause substantial losses. Thus, in this specific embodiment, custom designed Coanda effect valves are provided. These valves are based on bistable fluidic amplifiers that allow switching the direction of a jet 180 degrees at high speeds.

FIG. 16A provides an illustration of how the Coanda effect valve works. A jet is supplied to inlet I 1610, while control ports C1 and C2 can open to the ambient fluid or close and seal the port. If port C1 is opened while C2 is closed the jet will exit the nozzle, attach to the right side of the device, and exit through exit E2 1620. A CFD illustration of the fluid jet exiting exit E2 is provided in FIG. 16B. Similarly, if C1 is closed and C2 is opened, the jet will switch and exit through exit E1 1615. Note that the arrows associated with reference numbers 1615 and 1620 indicate exits E1 and E2, respectively, rather than the direction of the fluid output.

In a specific embodiment, applicants have designed these valves for the specific application of water jet propulsion. Computational fluid dynamics (CFD) and experiments have allowed for miniaturizing the design. In this specific embodiment, a special switching mechanism has been designed that uses a small direct current (DC) motor. The small DC motor is used to open and close the control ports, and requires simple commercially available electronics for control.

FIG. 17 shows an example of a built, tested, and verified prototype of a valve 1705 of an actuation unit. The valve includes an inlet 1710, a first exit 1715, and a second exit 1720. An angle between the first and second exit is about 180 degrees.

One of these valves can be attached to each of the two exit ports on the retrofitted pumps. This means that now a single pump can be engineered to provide an output jet in one of two pairs of directions or 4 directions total. This full manifestation may be referred to as a 2DOF actuation unit. These units can serve as the building blocks for robots, as they can be combined and rotated in order to meet the user requirements. FIG. 18 shows an example of a built, tested, and verified fully assembled 2DOF actuation unit.

As shown in the example of FIG. 18, an actuation unit 1805 includes a pump 1810, a first valve 1815, and a second valve 1820. The pump includes a first exit port 1825 and a second exit port 1830. An angle between the first and second exit ports is about 90 degrees. An inlet of the first valve is connected to the first exit port of the pump. An inlet of the second valve is connected to the second exit port of the pump. The valves have been mated to the pump such that one valve is rotated 90 degrees with respect to another valve. As a result, the exits of the valves are in different planes. For example, as shown in FIG. 18 an exit 1835 of the first valve is in a different plane with respect to an exit 1840 of the second valve. The exit of the first valve may be in a first plane parallel to the paper. The exit of the second valve may be in a second plane perpendicular to the paper.

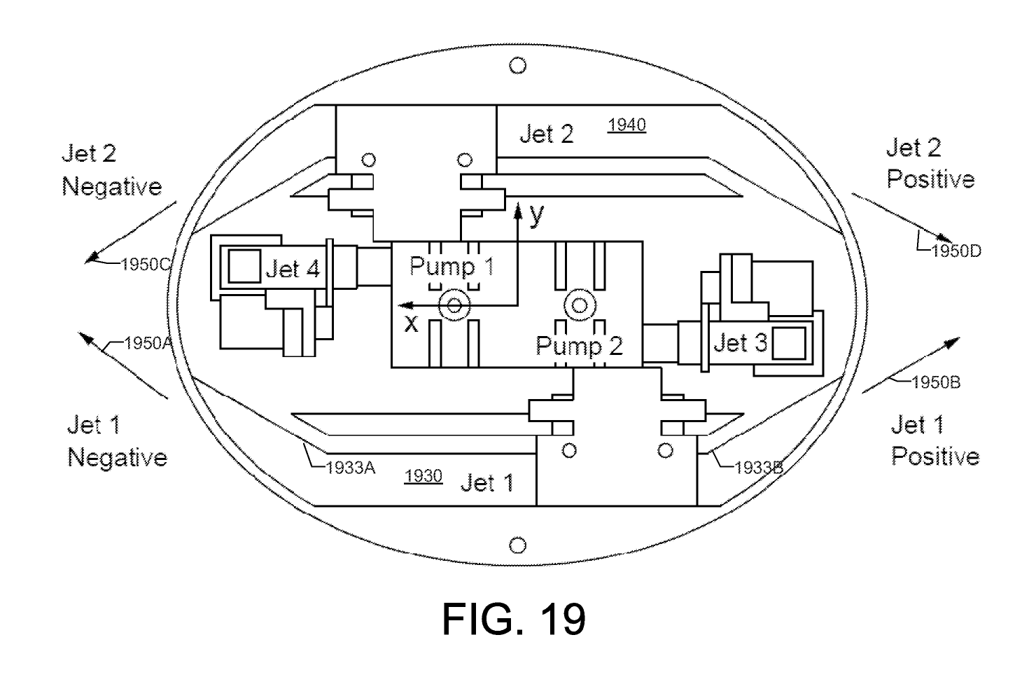

A specific embodiment provides for a 5 DOF underwater vehicle design using pump-valve architecture and angled jets. In this specific embodiment, this robot design incorporates two of the actuation units. An illustration of the layout is provided in FIG. 19. Pump 1 can produce Jet 2 or Jet 4 depending on direction, and Pump 2 can produce Jet 1 or Jet 3. Also note how Jets 1 and 2 are angled at their outputs. This is a key innovation of the design. This novel feature means that forces can be provided in both the “x” and “y” directions. The Omni-Egg design is capable of 5 DOF (surge (x), sway (y), heave (z), pitch (q), and yaw (r)).The coordinate frame is illustrated in FIG. 13.

As shown in FIG. 19, Jet 1 is directed through a first channel 1930. The ends of the channel are angled 1933A and 1933B. In a specific implementation, the angle is about 30 degrees from the x-axis. The angle may range from about 15 degrees to about 45 degrees. Similarly, Jet 2 is directed through a second channel 1940. The second channel may be similarly angled as the first channel. The angle of the channels allows Jets 1 and 2 to be angled at their outputs as shown by arrows 1950A-B. Arrows 1950A-B show the direction of the fluid jets from the robot. The angled direction of the fluid jets help to stabilize and control the movement of the robot.

During operation of the robot, the actuation units (e.g., pumps and valves) can be activated and deactivated to achieve the desired movement. In a specific implementation, Pump 1 generates one of Jet 2 or Jet 4. Pump 2 generates one of Jet 1 or Jet 3. The opening and closing of the valve control ports associated with a pump can be rapidly pulsed to achieve the desired movement.

Table C below provides a summary of maneuvering primatives for how each of these DOFs can be achieved.

TABLE C

| DOF | First Jet | Second Jet |
|---|---|---|
| +x | +Jet 1 | +Jet 2 |
| −x | −Jet 1 | −Jet 2 |
| +z | +Jet 3 | +Jet 4 |
| −z | −Jet 3 | −Jet 4 |
| +q | +Jet 4 | −Jet 3 |
| −q | −Jet 4 | +Jet 3 |
| +r | +Jet 1 | −Jet 2 |
| −r | −Jet 1 | +Jet 2 |
| +y | +Jet 1 | −Jet 1 |
| −y | +Jet 2 | −Jet 2 |

To achieve translations in the y direction, jets 1 and 2 are angled and then the high speed nature of the Coanda effect valve is used. By switching Jet 1 between positive and negative in a fast but symmetric manner, pure translation in the +y direction can be achieved because the x translations cancel out. This high speed switching is enabled by the use of the Coanda effect valve which has a response time that is much faster than the response time of the vehicle. Slower valves would cause the vehicle to wobble or oscillate. The use of the angled jets is one of the very unique features of this robot design.

Due to the Munk moment effect described in the background above, the yaw and pitch directions of the robot are unstable. Traditionally, these directions are stabilized using fins placed in the rear of the vehicle.

In a specific embodiment, stabilizing yaw is achieved without the use of external fins. In this specific embodiment, the use of external fins is avoided by using a combination of novel design and feedback control. Nonlinear and linearized models for these dynamics are provided in Appendix B. One thing to immediately note from the state space model is the coupling between the sway velocity “v” and the yaw angle “φ.” This unusual coupling is a result of the sideslip angle. Note that if the jets were not angled to produce forces along the “y” direction, the system would be theoretically uncontrollable.

Stabilizing the pitch direction is achieved by placing the center of mass below the geometric center of the robot. Errors in the pitch direction will be eventually balanced by gravitational forces and will therefore not grow unbounded. This solution allows the maintenance of the smooth external shape.

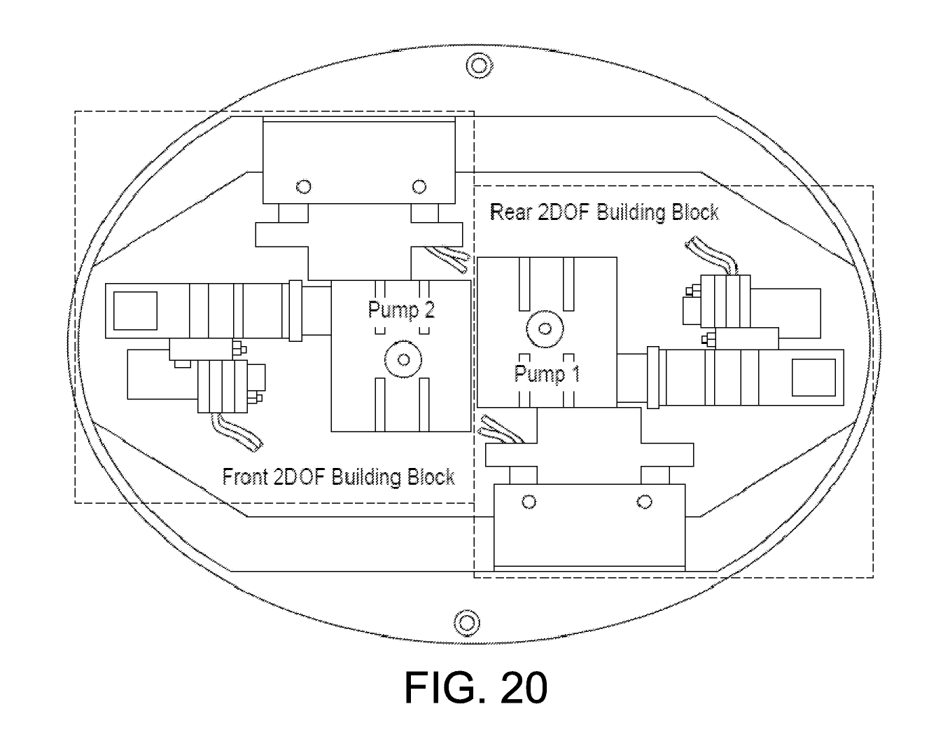

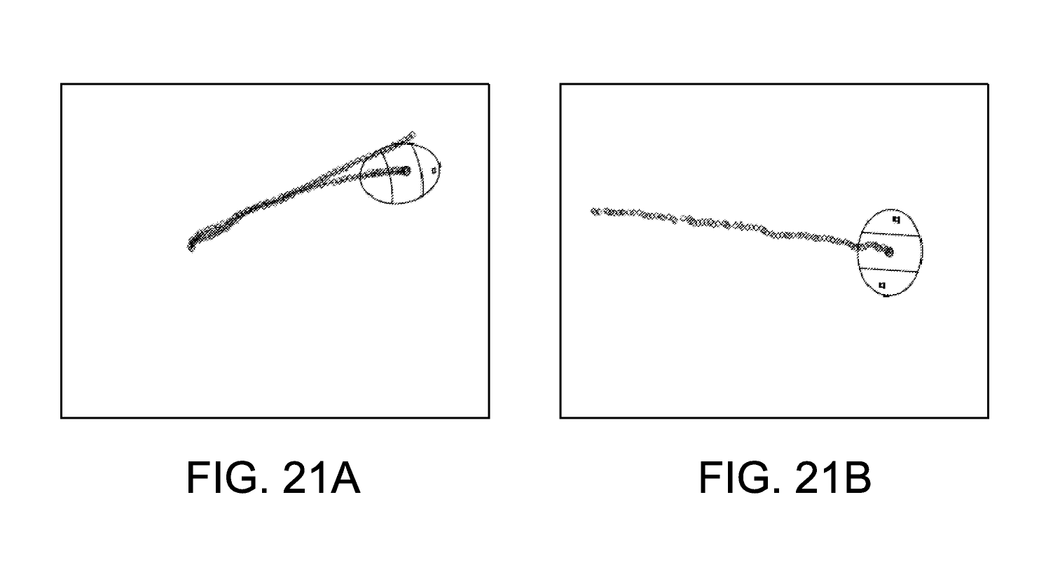

As discussed above, the full design has been realized and tested. FIG. 20 shows drawing of the physical prototype components. In addition, videos have been made of the robot performing several unique maneuvers. Two such maneuvers are illustrated in FIGS. 21A and 21B. FIG. 21A illustrates a “forward and reverse” test where the robot is commanded to go straight forward and then straight in reverse. This type of maneuver would be difficult if not impossible for a robot that used fins to stabilize it. FIG. 21B illustrates the “sway translation” test. Essentially the robot moves sideways. Many robots are not capable of this motion. These figures have been included in this patent application to highlight how the angled jets can be used to achieve motions in both surge and sway separately.

Some advantages of the robot include an outer surface that is entirely or substantially smooth, being capable of 5 degrees of freedom, and a 90 degree pump or a retrofitted pump to achieve large forces in 2 directions using a centrifugal pump. A specific embodiment of the robot is a robot that uses an entirely or substantially smooth shape without external propellers or fins. Other advantages of the robot include water jets manipulated by valves instead of servo motors, a lack of external stabilizes, more than 3 outlet directions for jets that provide the ability to translate in the sway direction, discrete jets for steering rather than vectored thrust, two pumps, angled jets, pumps with 90 degree outlets (which provide an increase in performance over pumps with 180 degree outlets), and others.

There many commercial applications for a robot as described in this patent application. One application includes the inspection of large water filled piping systems such as those inside nuclear, fossil fired, or hydroelectric power plants. The robot can be equipped to carry cameras that can take pictures and video of various inaccessible areas. In addition, water transport and sewage systems also require inspection and could make use of this robot or aspects of the robot for some of their larger piping systems. Further, this robot is very quiet and highly maneuverable. Therefore it could be relevant for underwater surveillance or other naval applications.

As discussed above, a prototype of the robot has been fully built and tested. Appendix A includes some photos of a prototype. FIG. A1 shows a top view of the robot. FIG. A2 shows an end view. FIG. A3 shows a bottom view. FIG. A4 shows a bottom view. FIG. A5 shows a front or first end view. FIG. A6 shows a back or second end view. FIG. A7 shows a perspective view of a valve. This view shows an intake port of the valve. Also shown is a winged flapper piece (shown in black) that pivots back and forth to control the opening and closing of the valve control ports. FIG. A8 shows a top view of the valve. A coin has been included in the photograph to show the relative size of the valve. FIG. A9 shows an example of an actuation unit. The actuation unit includes a pump and two valves attached to the pump. FIG. A10 shows a diagram of the inside of the robot. Various components of the robot are shown in color for clarity. FIGS. A11-A12 show diagrams illustrating the direction of the jets. A coordinate system has been shown for orientation. As discussed above, Jets 1 and 2 are angled at their outputs (FIG. A11).

FIG. A13 shows a photograph of the inside of the robot prototype. FIGS. A14-A15 show the robot having been placed in a body of liquid (e.g., water). A movement trace has been superimposed on the photos to show the movement of the robot through the water. FIGS. A16-A17 shows a photo of forward and backward trajectory and an accompanying time graph. FIGS. A18-A19 shows another photo of movement accompanying time graph. FIGS. A20-A21 shows another photo of movement accompanying time graph. FIGS. A22-A23 shows another photo of movement accompanying time graph.

In a specific implementation, a submersible mini-robot is provided that targets inspection of nuclear reactor internals and other critical components. The robot is designed to function wirelessly and without tethers, and has the ability to move in all directions to access difficult locations. Remote-operated vehicles developed for marine applications have proven successful for the visual inspection of submerged components in nuclear reactor vessels and spent fuel pools, but commercially available technologies have several limitations. The robot, as provided in this patent application represents a step-change improvement in the nuclear power industry's underwater inspection capabilities.

The robot is designed to allow safe, reliable, and non-intrusive operation while providing high-fidelity visual inspection across a broad range of components, configurations, and locations. A prototype robot has been built and tested. This robot features a compact and appendage-free design, a high degree of maneuverability, and wireless operation. In this specific embodiment, its ovoid form measures about 4 inches by 6 inches (i.e., 101.6 millimeters by 152.4 millimeters), allowing it to nestle comfortably in the palm of a hand. Its innovative propulsion and navigation system applies centrifugal pumps, high-speed valves, and maneuvering jets for precisely controlled motion.

The robot's shape and umbilical-free operation allow for successful in-plant applications. Many existing technologies employ propellers, rudders, and other appendages and attachments that limit access to some component locations and preclude certain types of motion. These appendages also may break off during collisions or snag on obstacles, creating the potential for contamination of carefully controlled reactor environments or other operational issues. The robot as provided in this patent application has demonstrated the ability to navigate through intricate and tight geometries and to conduct inspection-type passes over surfaces.

For example, under joystick control, it can dive and rise, turn in place, and move forward, backward, and sideways. The robot is capable of carrying cameras and includes a wireless communications system. In a specific embodiment, the payload includes two cameras. The first camera supports real-time navigation and visual examination by the robot operator, and the second camera captures higher-resolution imaging data for subsequent inspection, nondestructive evaluation, and asset management applications.

Improving wireless communications for submersed usage poses challenges. Water attenuates most frequencies, and systems and components pose complex configurations. Features of the robot combine optical communication capable of high data rates at a distance with radio communication capable of two-way data exchange when line of sight is lost between the mini-robot and its controller.

In the description above and throughout, numerous specific details are set forth in order to provide a thorough understanding of an embodiment of this disclosure. It will be evident, however, to one of ordinary skill in the art, that an embodiment may be practiced without these specific details. In other instances, well-known structures and devices are shown in block diagram form to facilitate explanation. The description of the preferred embodiments is not intended to limit the scope of the claims appended hereto. Further, in the methods disclosed herein, various steps are disclosed illustrating some of the functions of an embodiment. These steps are merely examples, and are not meant to be limiting in any way. Other steps and functions may be contemplated without departing from this disclosure or the scope of an embodiment.

What is claimed is:

1. An underwater robot comprising:
a body having a first end and a second end;
a propeller coupled to the first end of the body;
a controller having a processor for receiving sensor information and for causing control signals to be generated; and
first and second actuation units responsive to the controller processor control signals, wherein the first and second actuation units are inside the body, and each actuation unit includes a pump and two valves coupled to the pump,
wherein as the propeller propels the robot, the controller causes jets of fluid outputted from the first and second actuation units to stabilize the movement of the robot.

2. The underwater robot of claim 1 wherein the controller receives a first measurement and a second measurement, and based on a calculation involving the first and second measurements, control signals are generated to actuate at least one of the first or second actuation units to stabilize the movement of the robot, and
wherein the first measurement includes a yaw angle of the robot, and the second measurement includes a yaw rate of the robot.

3. The underwater robot of claim 2 wherein a sideslip angle of the robot is excluded from the calculation involving the first and second measurements.

4. The underwater robot of claim 2 wherein a sway velocity of the robot is excluded from the calculation involving the first and second measurements.

5. The underwater robot of claim 1 further comprising an inertial sensor to measure a yaw angle of the robot.

6. The underwater robot of claim 1 further comprising an inertial sensor to measure a yaw rate of the robot.

7. The underwater robot of claim 1 wherein when the propeller propels the robot in an x-direction, a first jet of fluid is outputted through a first valve of the first actuation unit in a y-direction, perpendicular to the x-direction.

8. The underwater robot of claim 1 wherein neither the first end nor the second end of the robot includes a fin.

9. The underwater robot of claim 1 wherein the first and second actuation units pumps include a reversible centrifugal pump.

10. A method for stabilizing an underwater robot moving in a first direction comprising:
measuring a yaw angle of the underwater robot;
measuring a yaw rate of the underwater robot;
using a processor associated with a controller, making a calculation involving the measured yaw angle and the measured yaw rate; and
based on the calculation, the controller generating signals for actuating at least one of a first jet, or a second jet to stabilize the underwater robot moving in the first direction, wherein the first jet is output in a second direction that is different from the first direction, and the second jet is output in a third direction that is different from the first direction.

11. The method of claim 10 wherein the second and third directions are perpendicular to the first direction, and the second and third directions are opposite to each other.

12. The method of claim 10 wherein the underwater robot further comprises a propeller coupled to an end of the robot.

13. The method of claim 10 wherein the underwater robot includes:
a first pump;
a first valve coupled to the first pump;
a second pump; and
a second valve coupled to the second pump,
wherein the first valve outputs the first jet, and the second valve outputs the second jet.

14. The method of claim 10 wherein a sway velocity of the robot is excluded from the calculation involving the measured yaw angle and measured yaw rate.

15. The method of claim 10 wherein a sideslip angle of the robot is excluded from the calculation involving the measured yaw angle and measured yaw rate.

16. The method of claim 10 wherein the underwater robot does not include a fin.

17. An underwater robot comprising:
a body;
a propeller coupled to an end of the body to move the underwater robot in a first direction;
a controller having a processor for receiving sensor information and for causing control signals to be generated;
a first pump responsive to the controller processor control signals, the first pump including a first valve for outputting a first jet of fluid in a second direction; and
a second pump responsive to the controller processor control signals, the second pump including a second valve for outputting a second jet of fluid in a third direction, wherein the second and third directions are perpendicular to the first direction, and the second and third directions are opposite to each other.

18. The underwater robot of claim 17 wherein the controller receives a first measurement, a second measurement, and based on a calculation involving the first and second measurements, the controller processor causes control signals to actuate at least one of the first jet of fluid in the second direction, or the second jet of fluid in the third direction, to counter a Munk moment effect as the underwater robot moves in the first direction, and
wherein the first measurement includes a yaw angle of the robot, and the second measurement includes a yaw rate of the robot.

19. The underwater robot of claim 17 wherein the underwater robot does not include a rudder.

20. The underwater robot of claim 17 wherein the underwater robot does not include a fin.
